(19) United States
(12) Patent Application Publication
(10) Pub. No.: US 2021/0238201 A1
(43) Pub. Date: Aug. 5, 2021

(54) ANTIMICROBIAL COMPOUNDS AND COMPOSITIONS

(71) Applicant: AGROFRESH INC., Philadelphia, PA (US)

(72) Inventors: Richard JACOBSON, Chalfont, PA (US); Daniel MacLEAN, Geneva, NY (US); Esther GACHANGO, Durham, NC (US)

(21) Appl. No.: 17/166,138

(22) Filed: Feb. 3, 2021

Related U.S. Application Data
(60) Provisional application No. 62/970,285, filed on Feb. 5, 2020.

(51) Int. Cl. C07F 5/02; A01N 55/00

(52) U.S. Cl. CPC C07F 5/02; A01N 55/00

(57) ABSTRACT

The present disclosure relates to compounds and/or compositions useful against pathogens affecting meats, plants, or plant parts. In particular, boron containing compounds are disclosed. Furthermore, the present disclosure relates to oxaboroles and methods of using oxaboroles.

### CROSS-REFERENCE TO RELATED APPLICATIONS

This application claims the benefit of U.S. Provisional Patent Application No. 62/970,285, filed Feb. 5, 2020, the entire disclosure of which is hereby incorporated by reference.

### BACKGROUND OF THE INVENTION

The present disclosure relates to compounds, and particularly to boron containing compounds. More particularly, the present disclosure relates to oxaboroles and methods of using oxaboroles.

### SUMMARY OF THE INVENTION

This invention is related to compounds and/or compositions useful against pathogens affecting meats, plants, or plant parts. In one embodiment, the provided compounds are products of certain oxaborole moieties. In a further embodiment, the compound comprises a di-oxaborole compound. Delivery systems are also provided to take advantage of the volatile nature of these compounds and/or compositions.

In one aspect, the disclosure relates to compounds having a structure of formula (A):

R^{A}—X¹-(G-X²)ₙ—R^{B} (A)

wherein,

each of R^{A} and R^{B} is independently an oxaborole;

X¹ and each X² are independently O, NH, or S;

each G is independently aryl, heteroaryl, arylalkyl, alkylarylalkyl, or C₁-C₈ alkyl, wherein each hydrogen atom in aryl, heteroaryl, arylalkyl, alkylarylalkyl, or C₁-C₈ alkyl is independently optionally substituted by deuterium, halogen, —OH, —CN, —OR, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;

each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F; and

n=0 to 4,

and agriculturally acceptable salts thereof.

Additional embodiments, features, and advantages of the disclosure will be apparent from the following detailed description and through practice of the disclosure. The compounds of the present disclosure can be described as embodiments in any of the following enumerated clauses. It will be understood that any of the embodiments described herein can be used in connection with any other embodiments described herein to the extent that the embodiments do not contradict one another.

1. A compound having a structure of formula (A):

R^{A}—X¹-(G-X²)ₙ—R^{B} (A)

wherein,

each of R^{A} and R^{B} is independently an oxaborole;

X¹ and each X² are independently O, NH, or S;

each G is independently aryl, heteroaryl, arylalkyl, alkylarylalkyl, or C₁-C₈ alkyl, wherein each hydrogen atom in aryl, heteroaryl, arylalkyl, alkylarylalkyl, or C₁-C₈ alkyl is independently optionally substituted by deuterium, halogen, —OH, —CN, —OR¹, —NH₂, —NH(C₁-C₆alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;

each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F; and

n=0 to 4,

and agriculturally acceptable salts thereof.

2. The compound of clause 1, wherein each G is independently aryl, heteroaryl, arylalkyl, alkylarylalkyl, or C₁-C₈ alkyl and wherein each hydrogen atom in aryl, heteroaryl, arylalkyl, alkylarylalkyl, or C₁-C₈ alkyl is independently optionally substituted by halogen, —OH, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —C₁-C₆ alkyl, —C₂-C₆ alkenyl, —C₂-C₆ alkynyl, —C₃-C₆ cycloalkyl, or 3-to 7-membered heterocycloalkyl, and

each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F,

and agriculturally acceptable salts thereof.

3. The compound of any of the preceding clauses or combination of clauses, wherein each G is independently aryl, heteroaryl, arylalkyl, alkylarylalkyl, or C₁-C₈ alkyl and wherein each hydrogen atom in aryl, heteroaryl, arylalkyl, alkylarylalkyl, or C₁-C₈ alkyl is independently optionally substituted by halogen, —OH, —OR¹, —C₁-C₆ alkyl, —C₂-C₆ alkenyl, —C₂-C₆ alkynyl, —C₃-C₆ cycloalkyl, or 3-to 7-membered heterocycloalkyl, and

each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F,

and agriculturally acceptable salts thereof.

4. The compound of any of the preceding clauses or combination of clauses, wherein G is C₁-C₈ alkyl, and wherein at least one hydrogen in C₁-C₈ alkyl is substituted by halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;

wherein each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F,

and agriculturally acceptable salts thereof.

5. The compound of any of the preceding clauses or combination of clauses, wherein at least one hydrogen in C₁-C₈ alkyl is substituted by halogen, —OH, —C₁-C₆ alkyl, or —OR, wherein each R¹ is independently deuterium or —C₁-C₆ alkyl,

and agriculturally acceptable salts thereof.

6. The compound of any of the preceding clauses or combination of clauses, wherein at least one hydrogen in C₁-C₈ alkyl is substituted by —OH or —C₁-C₆ alkyl,

and agriculturally acceptable salts thereof.

7. The compound of clause 1, wherein X¹-(G-X²)ₙ is of the formula

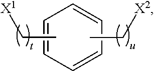

wherein t and u are each independently an integer from 0 to 6,

and agriculturally acceptable salts thereof.

8. The compound of any of the preceding clauses or combination of clauses, wherein each of t and u are an integer from 1 to 6,

and agriculturally acceptable salts thereof.

9. The compound of any of the preceding clauses or combination of clauses, wherein X¹ and each X² are independently O or NH,

and agriculturally acceptable salts thereof.

10. The compound of any of the preceding clauses or combination of clauses, wherein X is O and n=2 to 4,

and agriculturally acceptable salts thereof.

11. The compound of any of the preceding clauses or combination of clauses, wherein at least one X² is NH,

and agriculturally acceptable salts thereof.

12. The compound of any of the preceding clauses or combination of clauses, wherein X¹-(G-X²)ₙ is selected from the group consisting of

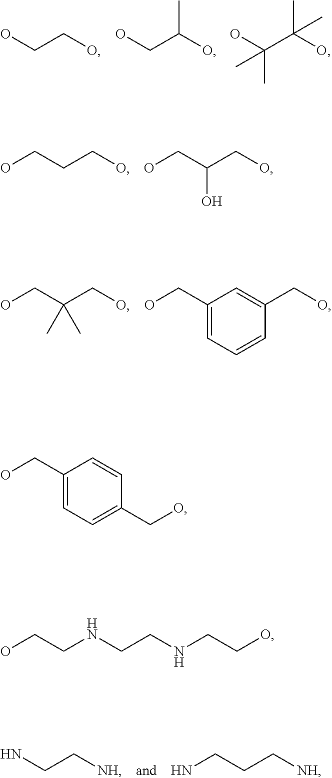

and agriculturally acceptable salts thereof.

13. The compound of any of the preceding clauses or combination of clauses, wherein X¹-(G-X²)ₙ is selected from the group consisting of

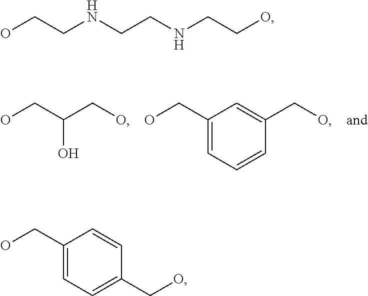

and agriculturally acceptable salts thereof.

14. The compound of any of the preceding clauses or combination of clauses, wherein n=0,

and agriculturally acceptable salts thereof.

15. The compound of any of the preceding clauses or combination of clauses, wherein n=1 to 4,

and agriculturally acceptable salts thereof.

16. The compound of any of the preceding clauses or combination of clauses, wherein each R^{A} and R^{B} are independently of formula (I)

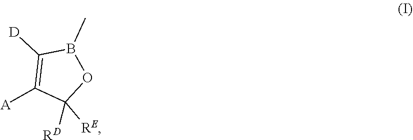

wherein A and D together with the carbon atoms to which they are attached form a 5, 6, or 7-membered fused ring which may be substituted by C₁₋₆-alkyl, C₁₋₆-alkoxy, hydroxy, halogen, nitro, nitrile, amino, amino substituted by one or more C₁₋₆-alkyl groups, carboxy, acyl, aryloxy, carbonamido, carbonamido substituted by C₁₋₆-alkyl, sulphonamido or trifluoromethyl, and

wherein R^{D} and R^{E} are independently hydrogen, substituted or unsubstituted C₁₋₆ alkyl, nitrile, nitro, aryl or arylalkyl; or R^{D} and R^{E} together form an alicyclic ring which is substituted or unsubstituted,

and agriculturally acceptable salts thereof.

17. The compound of any of the preceding clauses or combination of clauses, wherein each R^{A} and R^{B} are independently of formula (J)

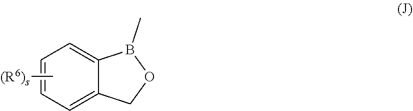

wherein s=0 to 4 and each R⁶ is independently alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sufide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy; and

agriculturally acceptable salts thereof.

18. A method of using a compound against pathogens affecting meats, plants, or plant parts, comprising contacting the meats, plants, or plant parts with an effective amount of the according to any one of clauses 1-17 or any combination of clauses 1-17.

19. The method of clause 18, wherein the compound is volatile.

20. The method of any of the preceding clauses or combination of clauses, wherein the compound is an antimicrobial, anti-decay, anti-spoilage, or pathogen control agent, or the like.

21. The method of any of the preceding clauses or combination of clauses, wherein the pathogen is selected from the group consisting of Acremonium spp., Albugo spp., Alternaria spp., Ascochyta spp., Aspergillus spp., Botryodiplodia spp., Botryospheria spp., Botrytis spp., Byssochlamys spp., Candida spp., Cephalosporium spp., Ceratocystis spp., Cercospora spp., Chalara spp., Cladosporium spp., Colletotrichum spp., Cryptosporiopsis spp., Cylindrocarpon spp., Debaryomyces spp., Diaporthe spp., Didymella spp., Diplodia spp., Dothiorella spp., Elsinoe spp., Fusarium spp., Geotrichum spp., Gloeosporium spp., Glomerella spp., Helminthosporium spp., Khuskia spp., Lasiodiplodia spp., Macrophoma spp., Macrophomina spp., Microdochium spp., Monilinia spp., Monilochaethes spp., Mucor spp., Mycocentrospora spp., Mycosphaerella spp., Nectria spp., Neofabraea spp., Nigrospora spp., Penicillium spp., Peronophythora spp., Peronospora spp., Pestalotiopsis spp., Pezicula spp., Phacidiopycnis spp., Phoma spp., Phomopsis spp., Phyllosticta spp., Phytophthora spp., Polyscytalum spp., Pseudocercospora spp., Pyricularia spp., Pythium spp., Rhizoctonia spp., Rhizopus spp., Sclerotium spp., Sclerotinia spp., Septoria spp., Sphaceloma spp., Sphaeropsis spp., Stemphyllium spp., Stilbella spp., Thielaviopsis spp., Thyronectria spp., Trachysphaera spp., Uromyces spp., Ustilago spp., Venturia spp., and Verticillium spp.

22. The method of any of the preceding clauses or combination of clauses, wherein the pathogen is selected from the group consisting of Bacillus spp., Campylobacter spp., Clavibacter spp., Clostridium spp., Erwinia spp., Escherichia spp., Lactobacillus spp., Leuconostoc spp., Listeria spp., Pantoea spp., Pectobacterium spp., Pseudomonas spp., Ralstonia spp., Salmonella spp., Shigella spp., Staphylococcus spp., Vibrio spp., Xanthomonas spp., and Yersinia spp. In another embodiment, the pathogen is selected from the group consisting of Cryptosporidium spp. and Giardia spp.

23. The method of clause 18, wherein the meats, plants, or plant parts are selected from the group consisting of barley, camphor tree, canola, castor-oil plant, cinnamon, cocoa, coffee, corn, cotton, flax, grapevine, hemp, hops, jute, maize, mustard, nuts, oat, poppy, rape, rice, rubber plant, rye, sunflower, sorghum, soybean, sugar cane, tea, tobacco, wheat, and a combination thereof.

24. The method of any of the preceding clauses or combination of clauses, wherein the plants are selected from the group consisting of almond, apple, avocado, banana, berry, carambola, cherry, citrus, coconut, fig, grapes, guava, kiwifruit, mango, nectarine, melons, olive, papaya, passionfruit, peach, pear, persimmon, pineapple, plum, pomegranate, and a combination thereof.

25. A method of preparing a compound comprising:

mixing at least one oxaborole compound with at least one adducting compound in a first organic solvent, wherein the at least one adducting compound comprises a diol or diamine compound; and

evaporating the first organic solvent by heating, thereby allowing the at least one adducting compound to react with the at least one oxaborole compound to generate at least one adducted product.

26. The method of clause 25, further comprising crystallizing the at least one adducted product using a second organic solvent.

27. The method of any of the preceding clauses or combination of clauses, wherein the first organic solvent is toluene.

28. The method of any of the preceding clauses or combination of clauses, wherein the second solvent is toluene or hexane.

29. The method of any of the preceding clauses or combination of clauses, wherein the diol or diamine has a formula

H—X¹-(G-X²)ₙ—H

wherein,

X¹ and each X² are independently O, NH, or S;

each G is independently aryl, heteroaryl, arylalkyl, alkylarylalkyl, or C₁-C₈ alkyl, wherein each hydrogen atom in aryl, heteroaryl, arylalkyl, alkylarylalkyl, or C₁-C₈ alkyl is independently optionally substituted by deuterium, halogen, —OH, —CN, —OR¹, —NH₂, —NH(C₁-C₆alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁-C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;

each R¹ is independently hydrogen, deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F; and

n=0 to 4.

30. The method of any of the preceding clauses or combination of clauses, wherein G is C₁-C₈ alkyl, and wherein at least one hydrogen in C₁-C₈ alkyl is substituted by halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;

wherein each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F.

31. The method of any of the preceding clauses or combination of clauses, wherein at least one hydrogen in C₁-C₈ alkyl is substituted by halogen, —OH, —C₁-C₆ alkyl, or —OR¹, wherein each R¹ is independently deuterium or —C₁-C₆ alkyl.

32. The method of any of the preceding clauses or combination of clauses, wherein at least one hydrogen in C₁-C₈ alkyl is substituted by —OH or —C₁-C₆ alkyl.

33. The method of any of the preceding clauses or combination of clauses, wherein X¹-(G-X²)ₙ is of the formula

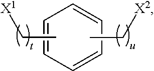

wherein t and u are each independently an integer from 0 to 6.

34. The method of any of the preceding clauses or combination of clauses, wherein each of q and r are an integer from 1 to 6.

35. The method of any of the preceding clauses or combination of clauses, wherein X is O and n=2 to 4.

36. The method of any of the preceding clauses or combination of clauses, wherein at least one X² is NH.

37. The method of any of the preceding clauses or combination of clauses, wherein the diol or diamine compound is selected from the group consisting of

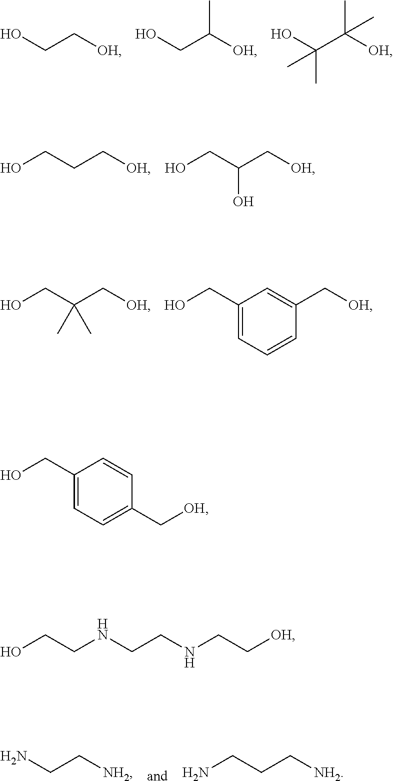

38. The method of any of the preceding clauses or combination of clauses, wherein the diol or diamine compound is selected from the group consisting of

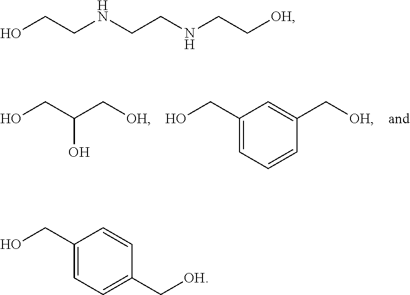 [SMILES: OCCNCCNCCO ; OCC(O)CO ; OCc1cccc(CO)c1 ; OCc1ccc(CO)cc1]

39. The method of any of the preceding clauses or combination of clauses, wherein the at least one oxaborole compound comprises a compound selected from the group consisting of 5-fluoro-1,3-dihydro-1-hydroxy-2,1-benzoxaborole; 5-chloro-1,3-dihydro-1-hydroxy-2,1-benzoxaborole; 1,3-dihydro-1-hydroxy-2,1-benzoxaborole; and combinations thereof.

40. The method of any of the preceding clauses or combination of clauses, wherein the at least one oxaborole compound comprises a compound of a structure selected from the group consisting of

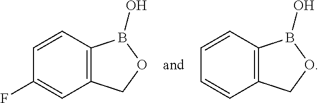 [SMILES: OB1OCc2cc(F)ccc21 ; OB1OCc2ccccc21]

41. The compound or method of any of the preceding clauses or combination of clauses, wherein the compound is not

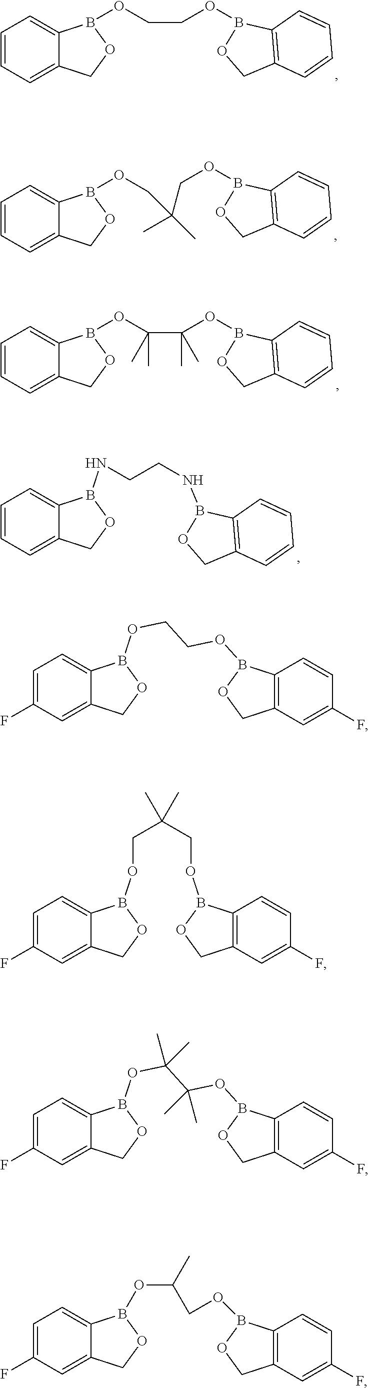

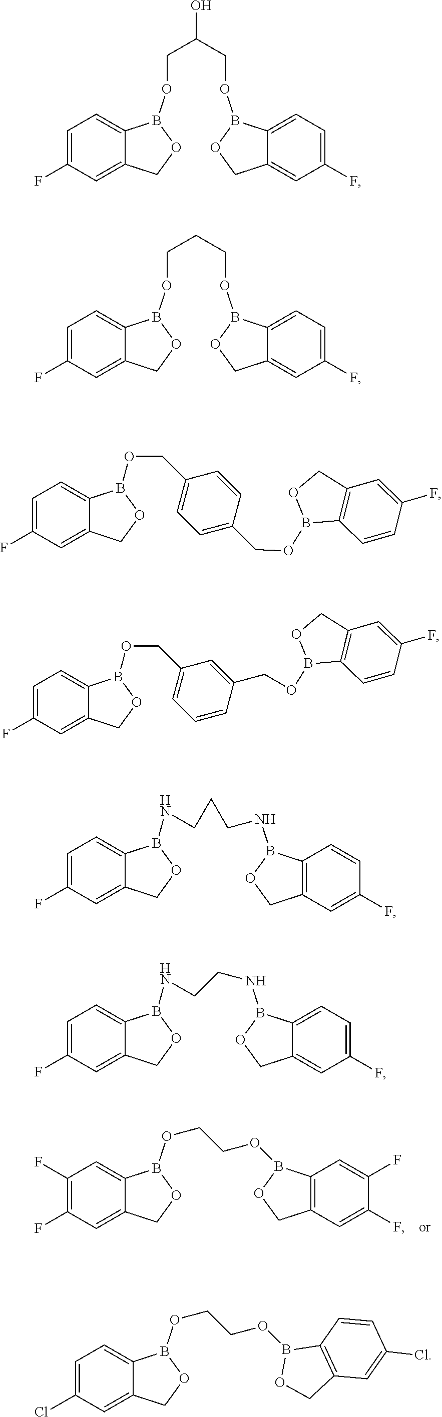

41. The compound or method of any of the preceding clauses or combination of clauses, wherein the compound is not

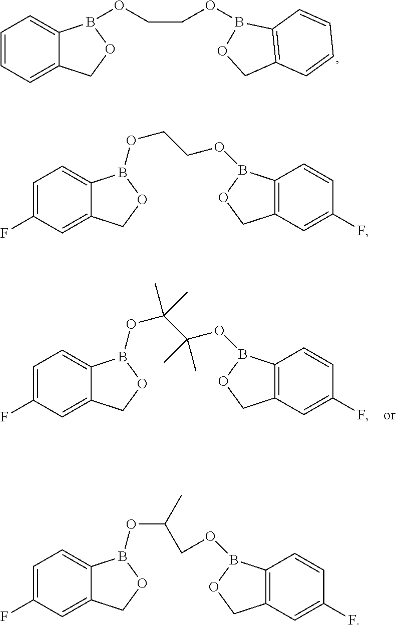 [SMILES: c1ccc2c(c1)COB2OCCOB1OCc2ccccc21 ; Fc1ccc2c(c1)COB2OCCOB1OCc2cc(F)ccc21 ; CC(C)(OB1OCc2cc(F)ccc21)C(C)(C)OB1OCc2cc(F)ccc21 ; CC(COB1OCc2cc(F)ccc21)OB1OCc2cc(F)ccc21]

42. The compound or method of any of the preceding clauses or combination of clauses, wherein X¹-(G-X²)ₙ is

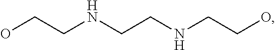

and agriculturally acceptable salts thereof.

43. The compound of clause 17, wherein R⁶ is halogen.

44. The compound of clause 17 or 43, wherein R⁶ is fluoro.

45. The compound of clause 17 or 43, wherein R⁶ is chloro.

46. The compound of clause 17, 43, 44, or 45, wherein s is 1.

47. The compound of clause 17, wherein s is 0.

48. The compound or method of any of the preceding or combination of clauses, wherein the compound is not

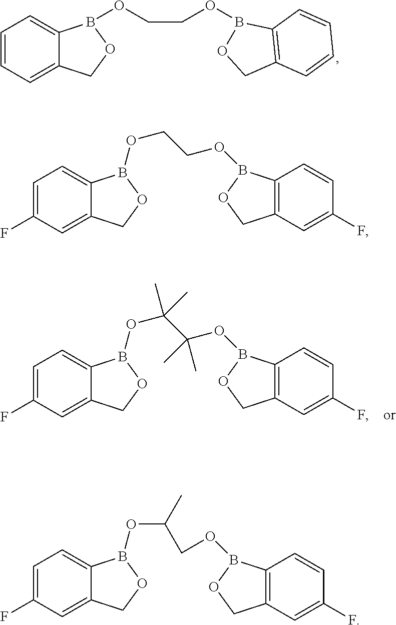 [SMILES: c1ccc2c(c1)COB2OCCOB1OCc2ccccc21 ; Fc1ccc2c(c1)COB2OCCOB1OCc2cc(F)ccc21 ; CC(C)(OB1OCc2cc(F)ccc21)C(C)(C)OB1OCc2cc(F)ccc21 ; CC(COB1OCc2cc(F)ccc21)OB1OCc2cc(F)ccc21]

48. The compound or method of any of the preceding or combination of clauses, wherein the compound is not

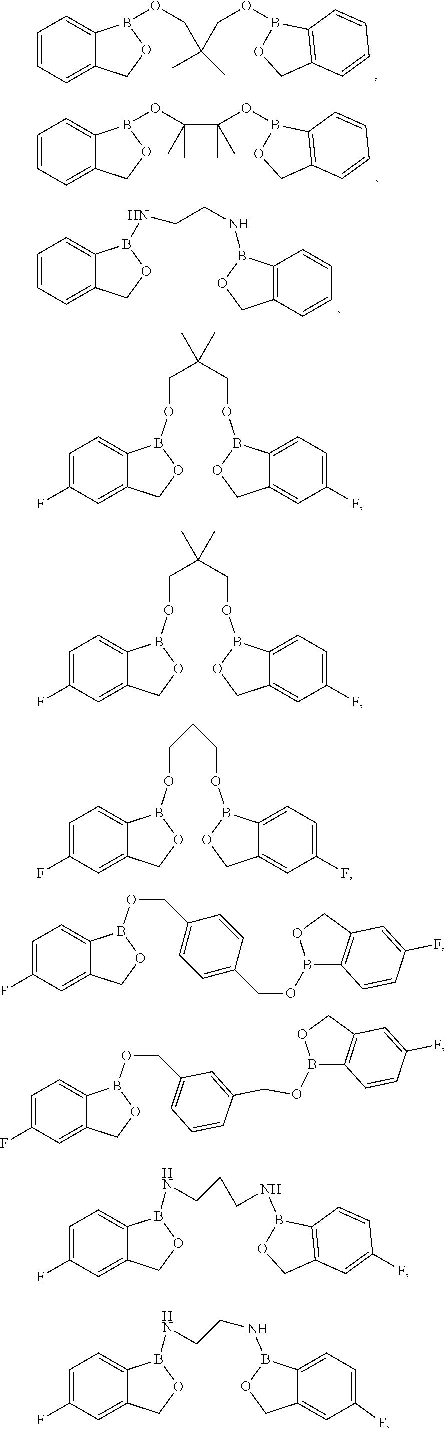

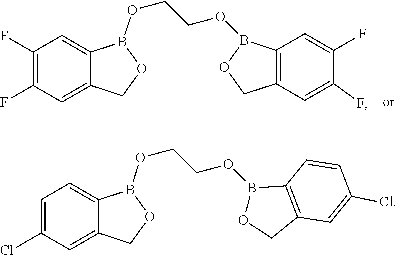 [SMILES: Fc1cc2c(cc1F)B(OCCOB1OCc3cc(F)c(F)cc31)OC2 ; Clc1ccc2c(c1)COB2OCCOB1OCc2cc(Cl)ccc21]

49. The compound or method of any of the preceding or combination of clauses, wherein at least two of X and X² are N.

50. The compound or method of any of the preceding or combination of clauses, wherein n is at least 2 and at least two of X¹ and X² are N.

51. The compound or method of any of the preceding or combination of clauses, wherein n is at least 2 and at least two of X¹ and X² are O.

52. The compound or method of any of the preceding or combination of clauses, wherein n is at least 2 and at least two of X¹ and X² are N and at least two of X¹ and X² are O,

53. The compound or method of any one of clauses 42 or 49-52, wherein and R^{A} and R^{B} are each independently 5-fluoro-1,3-dihydro-1-hydroxy-2,1-benzoxaborole; 5-chloro-1,3-dihydro-1-hydroxy-2,1-benzoxaborole; or 1,3-dihydro-1-hydroxy-2,1-benzoxaborole.

54. A salt comprising a compound of any of the preceding clauses and a counterion.

55. The salt of clause 54, wherein the counterion is a weak acid.

56. The salt of clause 54, wherein the counterion is K⁺ or Na⁺.

57. The salt of clause 54, wherein the salt is formed by treating the compound with an organic base.

58. The salt of clause 57, wherein the organic base is choline, a basic amino acids or other alkyl or alkanol amines, and other alkaline or alkaline earth metals.

### DETAILED DESCRIPTION OF THE INVENTION

The present disclosure is premised on the observation that the two to one adduct of oxaborole compounds with diols, diamines, or amino alcohols can (1) possess volatile properties at room temperature; and (2) have antimicrobial activity against pathogenic agents, including fungi such as Botrytis cinerea. One example includes the two to one adduct of 5-fluoro-1-hydroxy-2,1-benzoxaborole with ethylene glycol, which shows excellent activity against Botrytis cinerea. Volatile antimicrobial agents (for example antimicrobial, anti-decay, anti-spoilage, or pathogen control agent, or the like) have utility in postharvest disease control. Provided are methods reacting certain 1-hydroxyoxaborole compounds with a diol, a diamine, or an amino alcohol form compounds having antimicrobial activity, and compounds and/or compositions prepared by the methods disclosed.

As used herein, the term “alkyl” includes a chain of carbon atoms, which is optionally branched and contains from 1 to 20 carbon atoms. It is to be further understood that in certain embodiments, alkyl may be advantageously of limited length, including C₁-C₁₂, C₁-C₁₀, C₁-C₉, C₁-C₈, C₁-C₇, C₁-C₆, and C₁-C₄. Illustratively, such particularly limited length alkyl groups, including C₁-C₈, C₁-C₇, C₁-C₆, and C₁-C₄, and the like may be referred to as “lower alkyl.” Illustrative alkyl groups include, but are not limited to, methyl, ethyl, n-propyl, isopropyl, n-butyl, isobutyl, sec-butyl, tert-butyl, pentyl, 2-pentyl, 3-pentyl, neopentyl, hexyl, heptyl, octyl, and the like. Alkyl may be substituted or unsubstituted. Typical substituent groups include cycloalkyl, aryl, heteroaryl, heteroalicyclic, hydroxy, alkoxy, aryloxy, mercapto, alkylthio, arylthio, cyano, halo, carbonyl, oxo, (═O), thiocarbonyl, O-carbamyl, N-carbamyl, O-thiocarbamyl, N-thiocarbamyl, C-amido, N-amido, C-carboxy, O-carboxy, nitro, and amino, or as described in the various embodiments provided herein. It will be understood that “alkyl” may be combined with other groups, such as those provided above, to form a functionalized alkyl. By way of example, the combination of an “alkyl” group, as described herein, with a “carboxy” group may be referred to as a “carboxyalkyl” group. Other non-limiting examples include hydroxyalkyl, aminoalkyl, and the like.

As used herein, the term “alkenyl” includes a chain of carbon atoms, which is optionally branched, and contains from 2 to 20 carbon atoms, and also includes at least one carbon-carbon double bond (i.e. C═C). It will be understood that in certain embodiments, alkenyl may be advantageously of limited length, including C₂-C₁₂, C₂-C₉, C₂-C₈, C₂-C₇, C₂-C₆, and C₂-C₄. Illustratively, such particularly limited length alkenyl groups, including C₂-C₈, C₂-C₇, C₂-C₆, and C₂-C₄ may be referred to as lower alkenyl. Alkenyl may be unsubstituted, or substituted as described for alkyl or as described in the various embodiments provided herein. Illustrative alkenyl groups include, but are not limited to, ethenyl, 1-propenyl, 2-propenyl, 1-, 2-, or 3-butenyl, and the like.

As used herein, the term “alkynyl” includes a chain of carbon atoms, which is optionally branched, and contains from 2 to 20 carbon atoms, and also includes at least one carbon-carbon triple bond (i.e. C≡C). It will be understood that in certain embodiments, alkynyl may each be advantageously of limited length, including C₂-C₁₂, C₂-C₉, C₂-C₈, C₂-C₇, C₂-C₆, and C₂-C₄. Illustratively, such particularly limited length alkynyl groups, including C₂-C₈, C₂-C₇, C₂-C₆, and C₂-C₄ may be referred to as lower alkynyl. Alkenyl may be unsubstituted, or substituted as described for alkyl or as described in the various embodiments provided herein. Illustrative alkenyl groups include, but are not limited to, ethynyl, 1-propynyl, 2-propynyl, 1-, 2-, or 3-butynyl, and the like.

As used herein, the term “aryl” refers to an all-carbon monocyclic or fused-ring polycyclic groups of 6 to 12 carbon atoms having a completely conjugated pi-electron system. It will be understood that in certain embodiments, aryl may be advantageously of limited size such as C₆-C₁₀ aryl. Illustrative aryl groups include, but are not limited to, phenyl, naphthylenyl and anthracenyl. The aryl group may be unsubstituted, or substituted as described for alkyl or as described in the various embodiments provided herein.

As used herein, the term “cycloalkyl” refers to a 3 to 15 member all-carbon monocyclic ring, including an all-carbon 5-member/6-member or 6-member/6-member fused bicyclic ring, or a multicyclic fused ring (a “fused” ring system means that each ring in the system shares an adjacent pair of carbon atoms with each other ring in the system) group, where one or more of the rings may contain one or more double bonds but the cycloalkyl does not contain a completely conjugated pi-electron system. It will be understood that in certain embodiments, cycloalkyl may be advantageously of limited size such as C₃-C₁₃, C₃-C₉, C₃-C₆ and C₄-C₆. Cycloalkyl may be unsubstituted, or substituted as described for alkyl or as described in the various embodiments provided herein. Illustrative cycloalkyl groups include, but are not limited to, cyclopropyl, cyclobutyl, cyclopentyl, cyclopentenyl, cyclopentadienyl, cyclohexyl, cyclohexenyl, cycloheptyl, adamantyl, norbornyl, norbornenyl, 9H-fluoren-9-yl, and the like. Illustrative examples of cycloalkyl groups shown in graphical representations include the following entities, in the form of properly bonded moieties:

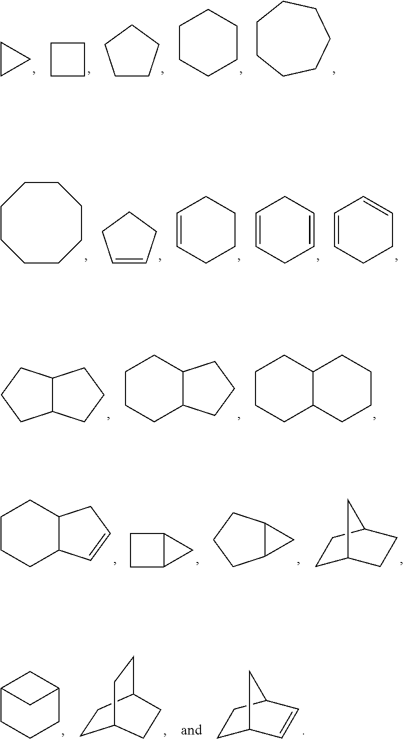

As used herein, the term “heterocycloalkyl” refers to a monocyclic or fused ring group having in the ring(s) from 3 to 12 ring atoms, in which at least one ring atom is a heteroatom, such as nitrogen, oxygen or sulfur, the remaining ring atoms being carbon atoms. Heterocycloalkyl may optionally contain 1, 2, 3 or 4 heteroatoms. Heterocycloalkyl may also have one or more double bonds, including double bonds to nitrogen (e.g. C═N or N═N) but does not contain a completely conjugated pi-electron system. It will be understood that in certain embodiments, heterocycloalkyl may be advantageously of limited size such as 3- to 7-membered heterocycloalkyl, 5- to 7-membered heterocycloalkyl, and the like. Heterocycloalkyl may be unsubstituted, or substituted as described for alkyl or as described in the various embodiments provided herein. Illustrative heterocycloalkyl groups include, but are not limited to, oxiranyl, thianaryl, azetidinyl, oxetanyl, tetrahydrofuranyl, pyrrolidinyl, tetrahydropyranyl, piperidinyl, 1,4-dioxanyl, morpholinyl, 1,4-dithianyl, piperazinyl, oxepanyl, 3,4-dihydro-2H-pyranyl, 5,6-dihydro-2H-pyranyl, 2H-pyranyl, 1, 2, 3, 4-tetrahydropyridinyl, and the like. Illustrative examples of heterocycloalkyl groups shown in graphical representations include the following entities, in the form of properly bonded moieties:

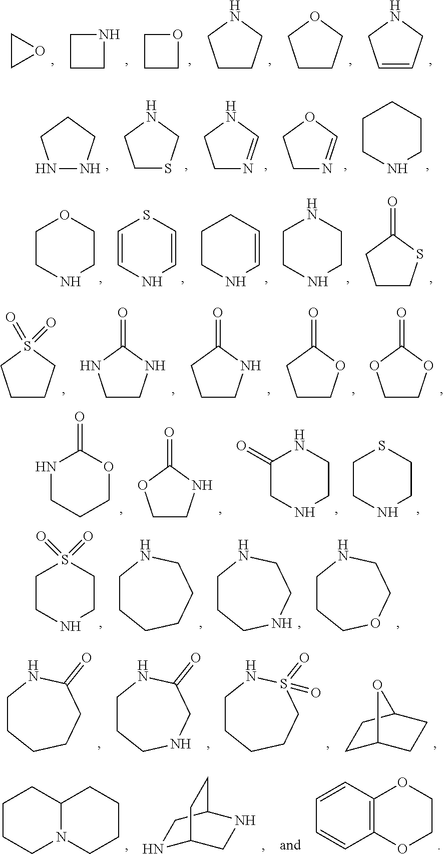

As used herein, the term “heteroaryl” refers to a monocyclic or fused ring group of 5 to 12 ring atoms containing one, two, three or four ring heteroatoms selected from nitrogen, oxygen and sulfur, the remaining ring atoms being carbon atoms, and also having a completely conjugated pi-electron system. It will be understood that in certain embodiments, heteroaryl may be advantageously of limited size such as 3- to 7-membered heteroaryl, 5- to 7-membered heteroaryl, and the like. Heteroaryl may be unsubstituted, or substituted as described for alkyl or as described in the various embodiments provided herein. Illustrative heteroaryl groups include, but are not limited to, pyrrolyl, furanyl, thiophenyl, imidazolyl, oxazolyl, thiazolyl, pyrazolyl, pyridinyl, pyrimidinyl, quinolinyl, isoquinolinyl, purinyl, tetrazolyl, triazinyl, pyrazinyl, tetrazinyl, quinazolinyl, quinoxalinyl, thienyl, isoxazolyl, isothiazolyl, oxadiazolyl, thiadiazolyl, triazolyl, benzimidazolyl, benzoxazolyl, benzthiazolyl, benzisoxazolyl, benzisothiazolyl and carbazoloyl, and the like. Illustrative examples of heteroaryl groups shown in graphical representations, include the following entities, in the form of properly bonded moieties:

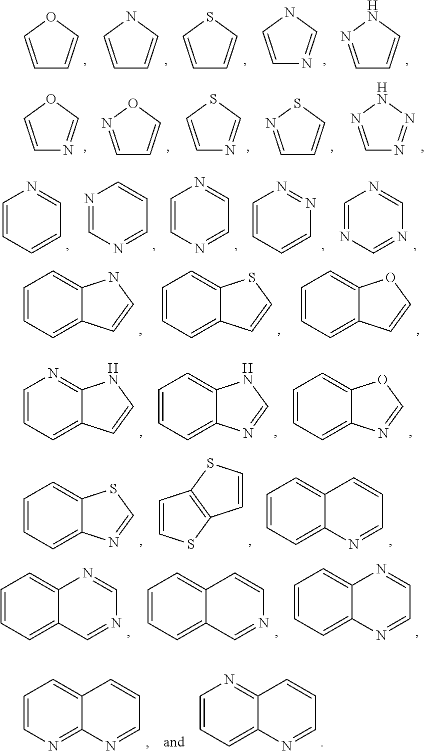

As used herein, “hydroxy” or “hydroxyl” refers to an —OH group.

As used herein, “alkoxy” refers to both an —O-(alkyl) or an —O-(unsubstituted cycloalkyl) group. Representative examples include, but are not limited to, methoxy, ethoxy, propoxy, butoxy, cyclopropyloxy, cyclobutyloxy, cyclopentyloxy, cyclohexyloxy, and the like.

As used herein, “aryloxy” refers to an —O-aryl or an —O-heteroaryl group. Representative examples include, but are not limited to, phenoxy, pyridinyloxy, furanyloxy, thienyloxy, pyrimidinyloxy, pyrazinyloxy, and the like, and the like.

As used herein, “mercapto” refers to an —SH group.

As used herein, “alkylthio” refers to an —S-(alkyl) or an —S-(unsubstituted cycloalkyl) group. Representative examples include, but are not limited to, methylthio, ethylthio, propylthio, butylthio, cyclopropylthio, cyclobutylthio, cyclopentylthio, cyclohexylthio, and the like.

As used herein, “arylthio” refers to an —S-aryl or an —S-heteroaryl group. Representative examples include, but are not limited to, phenylthio, pyridinylthio, furanylthio, thienylthio, pyrimidinylthio, and the like.

As used herein, “halo” or “halogen” refers to fluorine, chlorine, bromine or iodine.

As used herein, “cyano” refers to a —CN group.

The term “oxo” represents a carbonyl oxygen. For example, a cyclopentyl substituted with oxo is cyclopentanone.

As used herein, “bond” refers to a covalent bond.

The term “substituted” means that the specified group or moiety bears one or more substituents. The term “unsubstituted” means that the specified group bears no substituents. Where the term “substituted” is used to describe a structural system, the substitution is meant to occur at any valency-allowed position on the system. In some embodiments, “substituted” means that the specified group or moiety bears one, two, or three substituents. In other embodiments, “substituted” means that the specified group or moiety bears one or two substituents. In still other embodiments, “substituted” means the specified group or moiety bears one substituent.

As used herein, “optional” or “optionally” means that the subsequently described event or circumstance may but need not occur, and that the description includes instances where the event or circumstance occurs and instances in which it does not. For example, “wherein each hydrogen atom in C₁-C₆ alkyl, C₂-C₆ alkenyl, C₂-C₆ alkynyl, C₃-C₆ cycloalkyl, 3-to 7-membered heterocycloalkyl, C₆-C₁₀ aryl, or mono- or bicyclic heteroaryl is independently optionally substituted by C₁-C₆ alkyl” means that an alkyl may be but need not be present on any of the C₁-C₆ alkyl, C₂-C₆ alkenyl, C₂-C₆ alkynyl, C₃-C₆ cycloalkyl, 3-to 7-membered heterocycloalkyl, C₆-C₁₀ aryl, or mono- or bicyclic heteroaryl by replacement of a hydrogen atom for each alkyl group, and the description includes situations where the C₁-C₆ alkyl, C₂-C₆ alkenyl, C₂-C₆ alkynyl, C₃-C₆ cycloalkyl, 3-to 7-membered heterocycloalkyl, C₆-C₁₀ aryl, or mono- or bicyclic heteroaryl is substituted with an alkyl group and situations where the C₁-C₆ alkyl, C₂-C₆ alkenyl, C₂-C₆ alkynyl, C₃-C₆ cycloalkyl, 3-to 7-membered heterocycloalkyl, C₆-C₁₀ aryl, or mono- or bicyclic heteroaryl is not substituted with the alkyl group.

As used herein, “independently” means that the subsequently described event or circumstance is to be read on its own relative to other similar events or circumstances. For example, in a circumstance where several equivalent hydrogen groups are optionally substituted by another group described in the circumstance, the use of “independently optionally” means that each instance of a hydrogen atom on the group may be substituted by another group, where the groups replacing each of the hydrogen atoms may be the same or different. Or for example, where multiple groups exist all of which can be selected from a set of possibilities, the use of “independently” means that each of the groups can be selected from the set of possibilities separate from any other group, and the groups selected in the circumstance may be the same or different.

As used herein, the term “agriculturally acceptable salt” refers to those salts which counter ions which may be used in agriculture. Preferred agriculturally acceptable salts are those that are agriculturally effective and suitable for contact with the agricultural products without undue toxicity, irritation, or allergic response. A compound described herein may possess a sufficiently acidic group, a sufficiently basic group, both types of functional groups, or more than one of each type, and accordingly react with a number of inorganic or organic bases, and inorganic and organic acids, to form an agriculturally acceptable salt. Such salts include:

(1) acid addition salts, which can be obtained by reaction of the free base of the parent compound with inorganic acids such as hydrochloric acid, hydrobromic acid, nitric acid, phosphoric acid, sulfuric acid, and perchloric acid and the like, or with organic acids such as acetic acid, oxalic acid, (D) or (L) malic acid, maleic acid, methane sulfonic acid, ethanesulfonic acid, p-toluenesulfonic acid, phosphoric acids, salicylic acid, tartaric acid, citric acid, succinic acid or malonic acid and the like; or

(2) salts formed when an acidic proton present in the parent compound either is replaced by a metal ion, e.g., an alkali metal ion, an alkaline earth ion, or an aluminum ion; or coordinates with an organic base such as ethanolamine, diethanolamine, triethanolamine, trimethamine, N-methylglucamine, and the like.

Agriculturally acceptable salts are well known to those skilled in the art, and any such agriculturally acceptable salt may be contemplated in connection with the embodiments described herein. Examples of agriculturally acceptable salts include sulfates, pyrosulfates, bisulfates, sulfites, bisulfites, phosphates, monohydrogen-phosphates, dihydrogenphosphates, metaphosphates, pyrophosphates, chlorides, bromides, iodides, acetates, propionates, decanoates, caprylates, acrylates, formates, isobutyrates, caproates, heptanoates, propiolates, oxalates, malonates, succinates, suberates, sebacates, fumarates, maleates, butyne-1,4-dioates, hexyne-1,6-dioates, benzoates, chlorobenzoates, methylbenzoates, dinitrobenzoates, hydroxybenzoates, methoxybenzoates, phthalates, sulfonates, methylsulfonates, propylsulfonates, besylates, xylenesulfonates, naphthalene-1-sulfonates, naphthalene-2-sulfonates, phenylacetates, phenylpropionates, phenylbutyrates, citrates, lactates, γ-hydroxybutyrates, glycolates, tartrates, and mandelates

For a compound that contains a basic nitrogen, for example within a linker between two oxaborole moieties, an agriculturally acceptable salt may be prepared by any suitable method available in the art. For example, treatment of the free base with an inorganic acid, such as hydrochloric acid, hydrobromic acid, sulfuric acid, sulfamic acid, nitric acid, boric acid, phosphoric acid, and the like, or with an organic acid, such as acetic acid, phenylacetic acid, propionic acid, stearic acid, lactic acid, ascorbic acid, maleic acid, hydroxymaleic acid, isethionic acid, succinic acid, valeric acid, fumaric acid, malonic acid, pyruvic acid, oxalic acid, glycolic acid, salicylic acid, oleic acid, palmitic acid, lauric acid, a pyranosidyl acid, such as glucuronic acid or galacturonic acid, an alpha-hydroxy acid, such as mandelic acid, citric acid, or tartaric acid, an amino acid, such as aspartic acid or glutamic acid, an aromatic acid, such as benzoic acid, 2-acetoxybenzoic acid, naphthoic acid, or cinnamic acid, a sulfonic acid, such as laurylsulfonic acid, p-toluenesulfonic acid, methanesulfonic acid, or ethanesulfonic acid, or any compatible mixture of acids such as those given as examples herein, and any other acid and mixture thereof that are regarded as equivalents or acceptable substitutes in light of the ordinary level of skill in this technology.

In some embodiments, the salt is formed by treating a compound according to Formula (a) with a weak acid. In some embodiments the counterion to the salt is K⁺ or Na⁺. In some embodiments, the salt is formed by treating a compound Formula (a) with an organic base. Suitable organic bases include choline, basic amino acids, or other alkyl or alkanol amines, and other alkaline or alkaline earth metals.

Any formula depicted herein is intended to represent a compound of that structural formula as well as certain variations or forms. For example, a formula given herein is intended to include a racemic form, or one or more enantiomeric, diastereomeric, or geometric isomers, or a mixture thereof. Additionally, any formula given herein is intended to refer also to a hydrate, solvate, or polymorph of such a compound, or a mixture thereof. For example, it will be appreciated that compounds depicted by a structural formula containing the symbol “ [symbol] ” include both stereoisomers for the carbon atom to which the symbol “ [symbol] ” is attached, specifically both the bonds “ [symbol] ” and “ [symbol] ” are encompassed by the meaning of “ [symbol] ”.

Any formula given herein is also intended to represent unlabeled forms as well as isotopically labeled forms of the compounds. Isotopically labeled compounds have structures depicted by the formulas given herein except that one or more atoms are replaced by an atom having a selected atomic mass or mass number. Examples of isotopes that can be incorporated into compounds of the disclosure include isotopes of hydrogen, carbon, nitrogen, oxygen, phosphorous, fluorine, chlorine, and iodine, such as ²H, ³H, ¹¹C, ¹³C, ¹⁴C, ¹⁵N, ¹⁸O, ¹⁷O, ³¹P, ³²P, ³⁵S, ¹⁸F, ³⁶Cl, and ¹²⁵I, respectively. Such isotopically labelled compounds are useful in metabolic studies (preferably with ¹⁴C), reaction kinetic studies (with, for example ²H or ³H), detection or imaging techniques [such as positron emission tomography (PET) or single-photon emission computed tomography (SPECT)] including compound tissue distribution assays, or in radioactive treatment of an agricultural product. Further, substitution with heavier isotopes such as deuterium (i.e., ²H) may afford certain advantages resulting from greater metabolic stability, for example increased in vivo half-life or reduced dosage requirements. Isotopically labeled compounds of this disclosure can generally be prepared by carrying out the procedures disclosed in the schemes or in the examples and preparations described below by substituting a readily available isotopically labeled reagent for a non-isotopically labeled reagent.

Any disubstituent referred to herein is meant to encompass the various attachment possibilities when more than one of such possibilities are allowed. For example, a reference to disubstituent -A-B—, where A≠B, refers herein to such disubstituent with A attached to a first substituted member and B attached to a second substituted member, and it also refers to such disubstituent with A attached to the second substituted member and B attached to the first substituted member.

As used herein, the phrase “leaving group” refers to a group with the meaning conventionally associated with it in synthetic organic chemistry, i.e., an atom or group displaceable under substitution reaction conditions. Examples of leaving groups include, but are not limited to, halogen, alkane- or arylenesulfonyloxy, such as methanesulfonyloxy, ethanesulfonyloxy, thiomethyl, benzenesulfonyloxy, tosyloxy, and thienyloxy, dihalophosphinoyloxy, optionally substituted benzyloxy, isopropyloxy, acyloxy, and the like. In some embodiments, a leaving group can be HC(O)—COOH or RC(O)—COOH, wherein R is a C₁-C₆ alkyl or substituted C₁-C₆ alkyl.

The compounds of the invention as described herein may be synthesized using standard synthetic techniques known to those of skill in the art or using methods known in the art in combination with methods described herein. The starting materials used for the synthesis of the compounds of the invention as described herein can be obtained from commercial sources, such as Aldrich Chemical Co. (Milwaukee, Wis.), Sigma Chemical Co. (St. Louis, Mo.), or the starting materials can be synthesized. The compounds described herein, and other related compounds having different substituents can be synthesized using techniques and materials known to those of skill in the art, such as described, for example, in March, Advanced Organic Chemistry 4′ Ed. (1992) John Wiley & Sons, New York, N.Y.; Carey and Sundberg, Advanced Organic Chemistry 4^{th} Ed., Vols. A (2000) and B (2001) Plenum Press, New York, N.Y. and Greene and Wuts, Protective Groups in Organic Synthesis, 3rd Ed. (1999) John Wiley & Sons, New York, N.Y., (all of which are incorporated by reference in their entirety). General methods for the preparation of a compound as disclosed herein may be derived from known reactions in the field, and the reactions may be modified by the use of appropriate reagents and conditions, as would be recognized by the skilled person, for the introduction of the various moieties found in the formulae as provided herein. For example, the compounds described herein can be modified using various electrophiles or nucleophiles to form new functional groups or substituents.

In one aspect, provided is a compound having a structure of formula (A):

R^{A}—X¹-(G-X²)ₙ—R^{B} (A)

wherein,
each of R^{A} and R^{B} is independently an oxaborole;
X¹ and each X² are independently O, NH, or S;
each G is independently aryl, heteroaryl, arylalkyl, alkylarylalkyl, or C₁-C₈ alkyl, wherein each hydrogen atom in aryl, heteroaryl, arylalkyl, alkylarylalkyl, or C₁-C₈ alkyl is independently optionally substituted by deuterium, halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;
each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F; and
n=0 to 4,
and agriculturally acceptable salts thereof. In illustrative embodiments, the compound is not

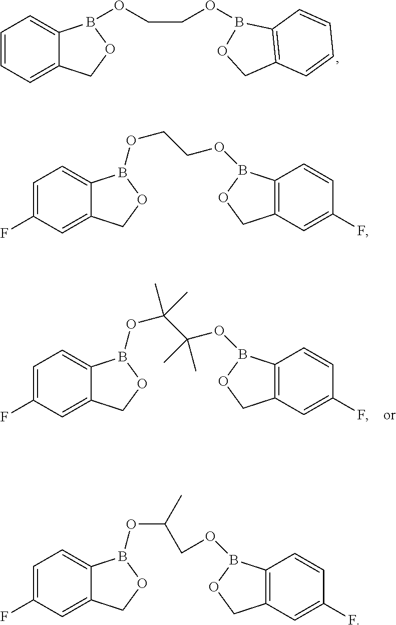 [SMILES: c1ccc2c(c1)COB2OCCOB1OCc2ccccc21 ; Fc1ccc2c(c1)COB2OCCOB1OCc2cc(F)ccc21 ; CC(C)(OB1OCc2cc(F)ccc21)C(C)(C)OB1OCc2cc(F)ccc21 ; CC(COB1OCc2cc(F)ccc21)OB1OCc2cc(F)ccc21]

In another embodiment, the compound is not

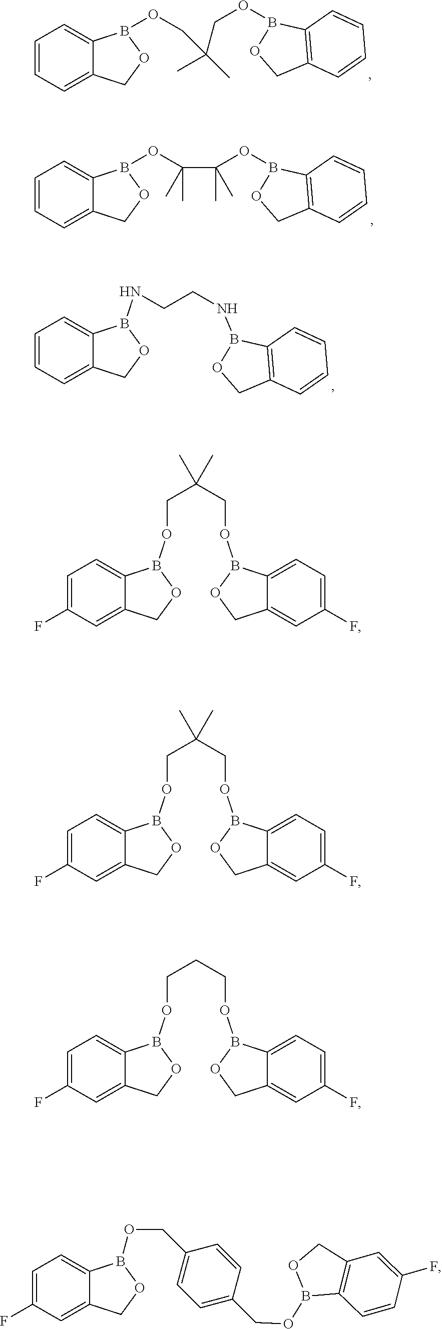

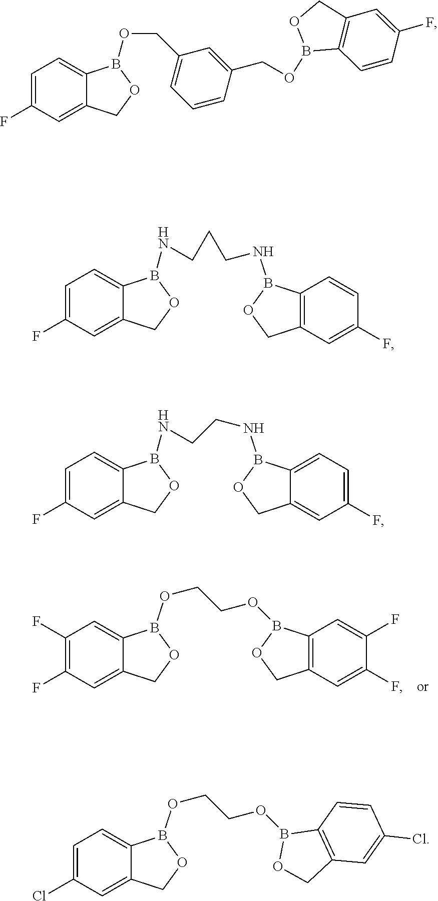 [SMILES: Fc1ccc2c(c1)COB2OCc1cccc(COB2OCc3cc(F)ccc32)c1 ; Fc1ccc2c(c1)COB2NCCCNB1OCc2cc(F)ccc21 ; Fc1ccc2c(c1)COB2NCCNB1OCc2cc(F)ccc21 ; Fc1cc2c(cc1F)B(OCCOB1OCc3cc(F)c(F)cc31)OC2 ; Clc1ccc2c(c1)COB2OCCOB1OCc2cc(Cl)ccc21]

In some embodiments, n is 0, 1, 2, 3, or 4. In some embodiments, n is at least 1, at least 2, or at least 3. In some embodiments, n is less than 4, less than 3, or less than 2. In some embodiments, X¹ is O. In some embodiments, X¹ is NH. In some embodiments, X¹ is S. In some embodiments, X² is O. In some embodiments, X² is NH. In some embodiments, X² is S. In some embodiments, n is at least 2 and at least one X² is NH. In some embodiments, n is at least 2 and at least one X² is O.

In some embodiments, G is C₁-C₈ alkyl, and at least one hydrogen in C₁-C₈ alkyl is substituted by halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F; wherein each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F. In some aspects, at least one hydrogen in C₁-C₈ alkyl is substituted by halogen, —OH, —C₁-C₆ alkyl, or —OR¹, wherein each R¹ is independently deuterium or —C₁-C₆ alky. In some embodiments, at least one hydrogen in C₁-C₈ alkyl is substituted by —OH or —C₁-C₆ alkyl. In some embodiments, G is not substituted.

In some embodiments, G is C₁-C₈ alkyl, and at least one hydrogen in C₁-C₈ alkyl is substituted by halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F, provided that at least one substitution is not C₁-C₆ alkyl; wherein each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F. In some aspects, at least one hydrogen in C₁-C₈ alkyl is substituted by halogen, —OH, or —OR¹, wherein each R¹ is independently deuterium or —C₁-C₆ alky. In some embodiments, at least one hydrogen in C₁-C₈ alkyl is substituted by —OH. In some embodiments, G is not substituted.

In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from a diol or diamine selected from the group consisting of 1,2-ethylene glycol; 1,2-propylene glycol; 1,3-propylene glycol; 1,1,2,2-tetramethyl-1,2-ethylene glycol; 2,2-dimethyl-1,3-propylene glycol; 1,6-hexanediol; 1,10-decanediol; 1,2-ethylene diamine; and 1,3-propylene diamine.

In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 1,2-ethylene glycol. In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 1,2-propylene glycol. In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 1,3-propylene glycol. In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 1,1,2,2-tetramethyl-1,2-ethylene glycol. In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 2,2-dimethyl-1,3-propylene glycol. In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 11,6-hexanediol. In some embodiments, if R^{A}, R^{B}, or both R^{A} and R^{B} is an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole, then X¹-(G-X²)ₙ is not derived from 1,10-decanediol. In some embodiments, X¹-(G-X²)ₙ is not derived from 1,2-ethylene diamine. In some embodiments, X¹-(G-X²)ₙ is not derived from 1,3-propylene diamine.

In some embodiments, at least two of X¹ and X² are N. In some embodiments, n is at least 2 and at least two of X¹ and X² are N, and R^{A} and R^{B} are preferably 5-fluoro-1,3-dihydro-1-hydroxy-2,1-benzoxaborole; 5-chloro-1,3-dihydro-1-hydroxy-2,1-benzoxaborole; or 1,3-dihydro-1-hydroxy-2,1-benzoxaborole. In some embodiments, n is at least 2 and at least two of X¹ and X² are 0, and R^{A} and R^{B} are preferably 5-fluoro-1,3-dihydro-1-hydroxy-2,1-benzoxaborole; 5-chloro-1,3-dihydro-1-hydroxy-2,1-benzoxaborole; or 1,3-dihydro-1-hydroxy-2,1-benzoxaborole. In some embodiments, n is at least 2 and at least two of X¹ and X² are N and at least two of X¹ and X² are 0, and R^{A} and R^{B} are preferably 5-fluoro-1,3-dihydro-1-hydroxy-2,1-benzoxaborole; 5-chloro-1,3-dihydro-1-hydroxy-2,1-benzoxaborole; or 1,3-dihydro-1-hydroxy-2,1-benzoxaborole. In some embodiments, X¹-(G-X²)ₙ is —O(CH₂)₂NH(CH₂)₂N(H)(CH₂)₂O—, and R^{A} and R^{B} are preferably 5-fluoro-1,3-dihydro-1-hydroxy-2,1-benzoxaborole; 5-chloro-1,3-dihydro-1-hydroxy-2,1-benzoxaborole; or 1,3-dihydro-1-hydroxy-2,1-benzoxaborole.

In some embodiments, X¹-(G-X²)ₙ is not derived from a diol or diamine selected from the group consisting of 1,2-ethylene glycol; 1,2-propylene glycol; 1,3-propylene glycol; 1,1,2,2-tetramethyl-1,2-ethylene glycol; 2,2-dimethyl-1,3-propylene glycol; 1,6-hexanediol; 1,10-decanediol; 1,2-ethylene diamine; and 1,3-propylene diamine.

In some embodiments, X¹-(G-X²)ₙ is not derived from 1,2-ethylene glycol. In some embodiments, X¹-(G-X²)ₙ is not derived from 1,2-propylene glycol. In some embodiments, X¹-(G-X²)ₙ is not derived from 1,3-propylene glycol. In some embodiments, X¹-(G-X²)ₙ is not derived from 1,1,2,2-tetramethyl-1,2-ethylene glycol. In some embodiments, X¹-(G-X²)ₙ is not derived from 2,2-dimethyl-1,3-propylene glycol. In some embodiments, X¹-(G-X²)ₙ is not derived from 11,6-hexanediol. In some embodiments, X¹-(G-X²)ₙ is not derived from 1,10-decanediol. In some embodiments, X¹-(G-X²)ₙ is not derived from 1,2-ethylene diamine. In some embodiments, X¹-(G-X²) is not derived from 1,3-propylene diamine.

In some embodiments, R^{A}, R^{B}, or both R^{A} and R^{B} is not an oxaborole selected from the group consisting of 5-fluoro-1,3-dihydro-1-hydroxy-2,1-benzoxaborole; 5-chloro-1,3-dihydro-1-hydroxy-2,1-benzoxaborole; and 1,3-dihydro-1-hydroxy-2,1-benzoxaborole. In some embodiments R^{A}, R^{B}, or both R^{A} and R^{B} is not 5-fluoro-1,3-dihydro-1-hydroxy-2,1-benzoxaborole. In some embodiments R^{A}, R^{B}, or both R^{A} and R^{B} is not 5-chloro-1,3-dihydro-1-hydroxy-2,1-benzoxaborole. In some embodiments R^{A}, R^{B}, or both R^{A} and R^{B} is not 1,3-dihydro-1-hydroxy-2,1-benzoxaborole.

In some embodiments, the compound is not

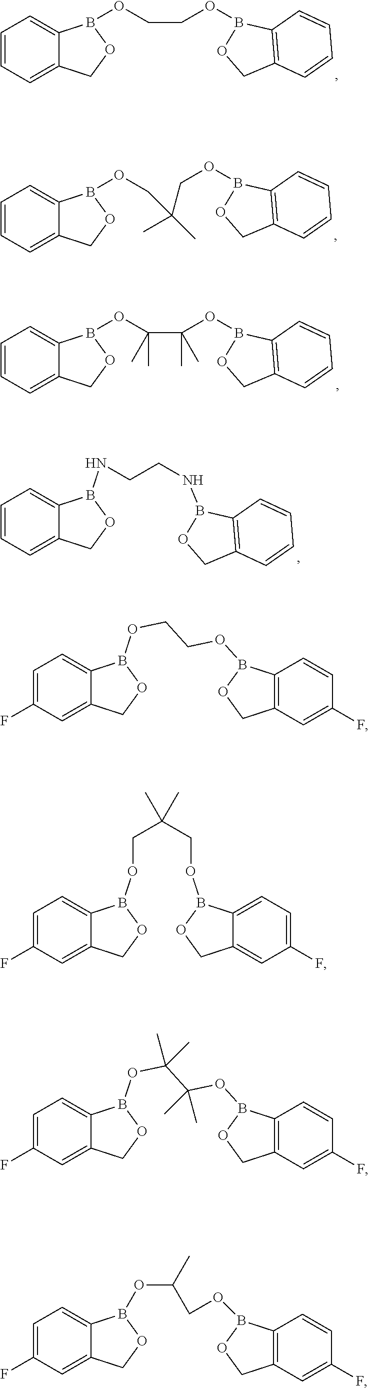

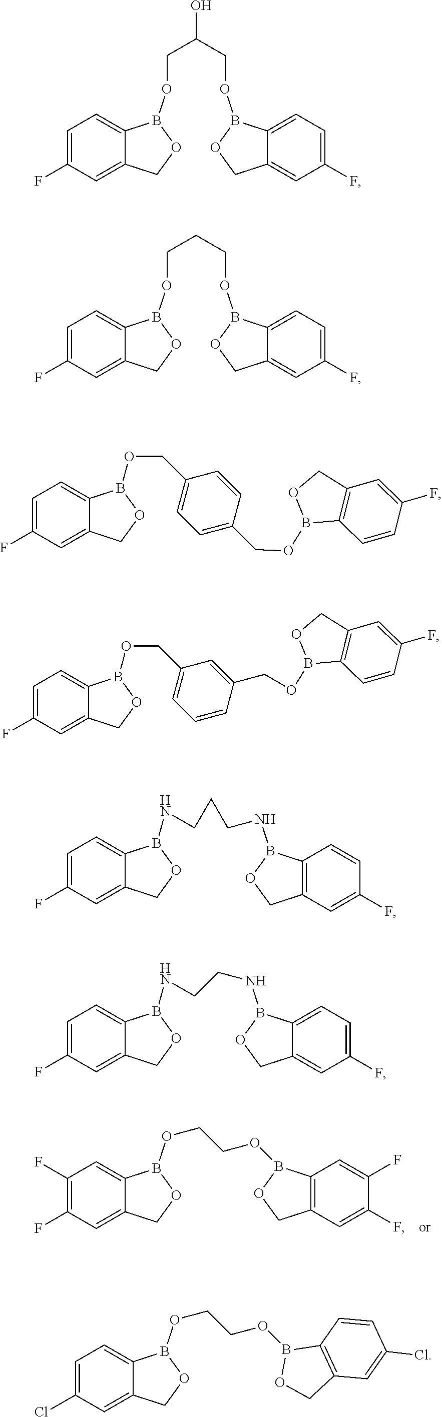

In some embodiments, the compound is not

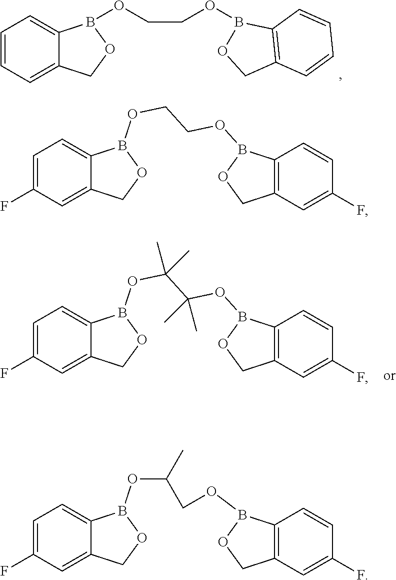 [SMILES: c1ccc2c(c1)COB2OCCOB1OCc2ccccc21 ; Fc1ccc2c(c1)COB2OCCOB1OCc2cc(F)ccc21 ; CC(C)(OB1OCc2cc(F)ccc21)C(C)(C)OB1OCc2cc(F)ccc21 ; CC(COB1OCc2cc(F)ccc21)OB1OCc2cc(F)ccc21]

In some embodiments, X¹-(G-X²)ₙ is derived from a diol, a diamine, or an amino alcohol, each of which is optionally substituted. In some embodiments, X¹-(G-X²) is of the formula

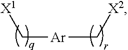

wherein q and r are each independently an integer from 0 to 6, and Ar is aryl or heteroaryl. In some embodiments, the aryl or heteroaryl ring is optionally substituted. In some aspects, q and r are independently 0, 1, 2, 3, 4, 5, or 6. In some embodiments, n is at least 1, at least 2, at least 3, at least 4, at least 5, or at least 6.

In some embodiments, X¹-(G-X²)ₙ is of the formula

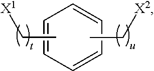

wherein q and r are each independently an integer from 0 to 6. In some aspects, t and u are independently 0, 1, 2, 3, 4, 5, or 6. In some embodiments, the phenyl ring is optionally substituted. In some embodiments, n is at least 1, at least 2, at least 3, at least 4, at least 5, or at least 6. In some embodiments, the substitution pattern for the X and X² substituents on the aryl ring is 1,2; 1,3; or 1,4.

In some embodiments, X-(G-X²)ₙ is derived from a diol or a diamine, each of which is optionally substituted. In some embodiments, X¹-(G-X²)ₙ is selected from the group consisting of

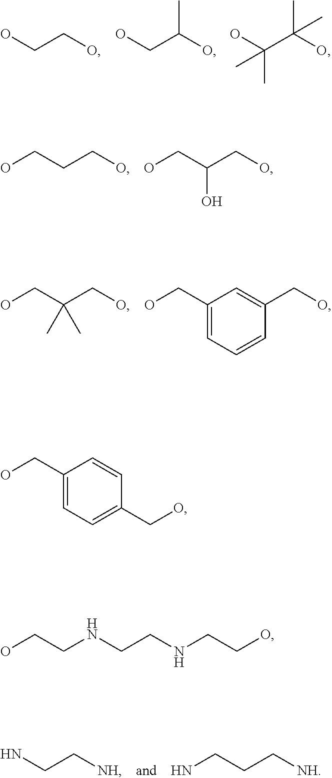

Additional oxaboroles, dioxaboroles, and methods for preparation and use are disclosed in U.S. Pat. Nos. 8,669,207 and 9,138,001 and U.S. Provisional Patent Application Nos. 61/831,187 and 61/758,313, the contents of each of which are hereby incorporated by reference in its entirety.

In another aspect, provided is a compound having a structure of formula (T):

R^{A}-L^{A}-G-L^{B}-R^{B} (T),

wherein
each of R^{A} and R^{B} is independently a radical comprising an oxaborole moiety;
each of L^{A} and L^{B} is independently —O— or

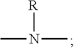

each of R and R′ is independently hydrogen, unsubstituted or substituted C₁-C₁₈-alkyl, arylalkyl, aryl, or heterocyclic moiety; and
G is a substituted or unsubstituted C₁₋₁₈-alkylene, arylalkylene, arylene, or heterocyclic moiety; and agriculturally acceptable salts thereof.

In one embodiment, the volatile compound is an antimicrobial compound. In another embodiment, the volatile compound has use against pathogens affecting meats, plants, or plant parts, comprising contacting the meats, plants, or plant parts. In another embodiment, the -L^{A}-G-L^{B}- portion of formula (T) is derived from a diol or diamine compound. In a further embodiment, the diol compound is selected from the group consisting of 1,2-ethylene glycol; 1,2-propylene glycol; 1,3-propylene glycol; 1,1,2,2-tetramethyl-1,2-ethylene glycol; 2,2-dimethyl-1,3-propylene glycol; 1,6-hexanediol; 1,10-decanediol; and combinations thereof. In another embodiment, the diamine compound is 1,2-ethylene diamine; 1,3-propylene diamine; or combinations thereof. In another embodiment, L^{A} and L^{B} are identical. In another embodiment, L^{A} and L^{B} are different. In another embodiment, each of L^{A} and L^{B} is independently —O— or —NH—. In another embodiment, L^{A} and L^{B} are identical. In another embodiment, L^{A} and L^{B} are different.

In another embodiment, the -L^{A}-G-L^{B}- portion of formula (T) comprises asymmetrical functional groups (i.e., asymmetrical bridges). In a further embodiment, the -L^{A}-G-L^{B}- portion of formula (T) comprises one hydroxyl group and one amine group. In a further embodiment, the -L^{A}-G-L^{B}- portion of formula (T) comprises an amino alcohol. In another embodiment, G is a substituted or unsubstituted C₁₋₈-alkylene. In a further embodiment, G is a substituted or unsubstituted C₁₋₄-alkylene. In a further embodiment, G is selected from —CH₂—, —CH₂—CH₂—, and —CH₂—CH₂—CH₂—.

In another embodiment, each of R^{A} and R^{B} is independently derived from the group consisting of 5-fluoro-1,3-dihydro-1-hydroxy-2,1-benzoxaborole; 5-chloro-1,3-dihydro-1-hydroxy-2,1-benzoxaborole; 1,3-dihydro-1-hydroxy-2,1-benzoxaborole; and combinations thereof. In another embodiment, R^{A} and R^{B} are identical. In another embodiment, R^{A} and R^{B} are different.

In another embodiment, at least one of R^{A} and R^{B} is selected from formula (B), (C), or (D):

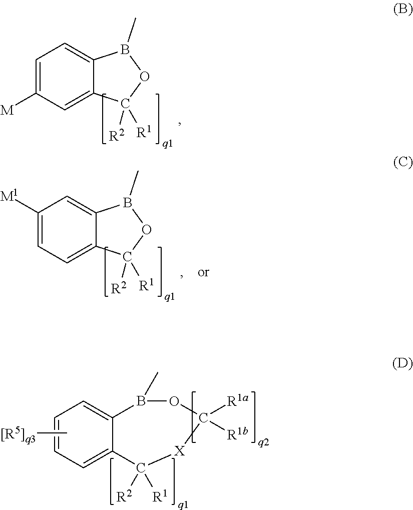

wherein q1 and q2 are independently 1, 2, or 3;

q3=0, 1, 2, 3, or 4;

B is boron;

M is hydrogen, halogen, —OCH₃, or —CH₂—O—CH₂—O—CH₃;

M¹ is halogen, —CH₂OH, or —OCH₃;

X is O, S, or NR^{1c}, wherein R^{1c} is hydrogen, substituted alkyl, or unsubstituted alkyl;

R¹, R^{1a}, R^{1b}, R², and R⁵ are independently hydrogen, OH, NH₂, SH, CN, NO₂, SO₂, OSO₂OH, OSO₂NH₂, substituted or unsubstituted cycloalkyl, substituted or unsubstituted heterocycloalkyl, substituted or unsubstituted aryl, or substituted or unsubstituted heteroaryl;

and agriculturally acceptable salts thereof.

Additional oxaborole moieties are also disclosed previously in U.S. Pat. No. 8,106,031, and International Patent Application WO 2007/131072A2, the contents of each of which are hereby incorporated by reference in their entireties.

In another embodiment, at least one of R^{A} and R^{B} has a structure of formula (F):

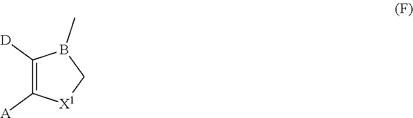

wherein A and D together with the carbon atoms to which they are attached form a 5, 6, or 7-membered fused ring which may be substituted by C₁₋₆-alkyl, C₁₋₆-alkoxy, hydroxy, halogen, nitro, nitrile, amino, amino substituted by one or more C₁₋₆-alkyl groups, carboxy, acyl, aryloxy, carbonamido, carbonamido substituted by C₁₋₆-alkyl, sulphonamido or trifluoromethyl or the fused ring may link two oxaborole rings; B is boron;

X¹ is a group —CR⁷R⁸ wherein R⁷ and R⁸ are each independently hydrogen, C₁₋₆-alkyl, nitrile, nitro, aryl, aralkyl or R⁷ and R⁸ together with the carbon atom to which they are attached form an alicyclic ring; and

and agriculturally acceptable salts thereof.

In another embodiment, each R^{A} and R^{B} are independently of formula (I)

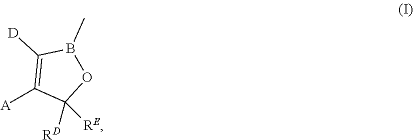

wherein A and D together with the carbon atoms to which they are attached form a 5, 6, or 7-membered fused ring which may be substituted by C₁₋₆-alkyl, C₁₋₆-alkoxy, hydroxy, halogen, nitro, nitrile, amino, amino substituted by one or more C₁₋₆-alkyl groups, carboxy, acyl, aryloxy, carbonamido, carbonamido substituted by C₁₋₆-alkyl, sulphonamido or trifluoromethyl, and

wherein R^{D} and R^{E} are independently hydrogen, substituted or unsubstituted C₁₋₆ alkyl, nitrile, nitro, aryl or arylalkyl; or R^{D} and R^{E} together form an alicyclic ring which is substituted or unsubstituted.

In another embodiment, each R^{A} and R^{B} are independently of formula (J)

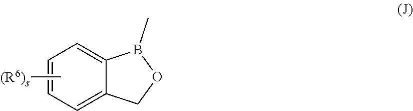

wherein s=0 to 4 and each R⁶ is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sufide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy

Additional oxaborole moieties are also disclosed previously in U.S. Pat. No. 5,880,188, the content of which is hereby incorporated by reference in its entirety.

In another embodiment, at least one of R^{A} and R^{B} is selected from formula (E) or (G):

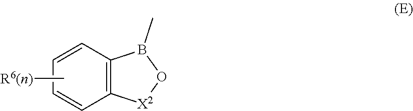

wherein each R⁶ is independently hydrogen, alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sufide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy;

n=1, 2, 3, or 4;

B is boron;

X²═(CR⁶₂)ₘ where m=1, 2, 3, or 4; or

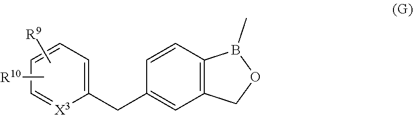

wherein R⁹ is CN, C(O)NR¹¹R¹², or C(O)OR³ wherein R³ is hydrogen, substituted alkyl, or unsubstituted alkyl,

X³ is N, CH and CR⁰;

R¹⁰ is halogen, substituted or unsubstituted alkyl, C(O)R¹⁴, C(O)OR¹⁴, OR¹⁴, NR¹⁴R¹⁵, wherein each of R¹¹, R¹², R¹⁴, and R¹⁵ is independently hydrogen, substituted or unsubstituted alkyl, substituted or unsubstituted heteroalkyl, substituted or unsubstituted cycloalkyl, substituted or unsubstituted heterocycloalkyl, substituted or unsubstituted aryl, or substituted or unsubstituted heteroaryl;

and agriculturally acceptable salts thereof.

In a further embodiment when at least one of R^{A} and R^{B} has a structure of formula (G), R⁹ is CN and R¹⁰ is R^{b}.

In another embodiment, at least one of R^{A} and R^{B} has a structure selected from:

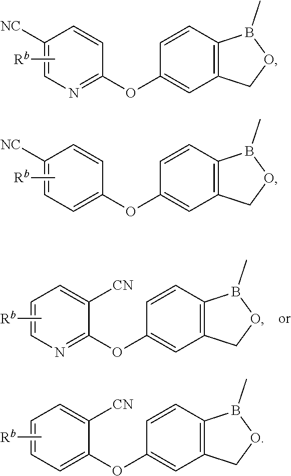

In another embodiment, at least one of R^{A} and R^{B} has a structure selected from:

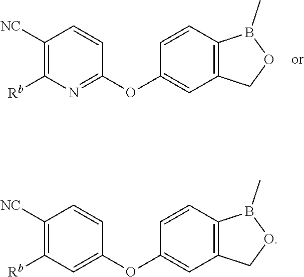

In another embodiment, at least one of R^{A} and R^{B} has a structure selected from:

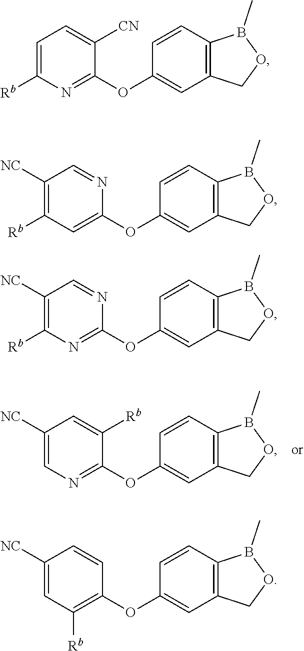

In another embodiment when at least one of R^{A} and R^{B} has a structure of formula (G), R⁹ is —COOR³ and R¹⁰ is R^{b}.

In another embodiment, at least one of R^{A} and R^{B} has a structure selected from:

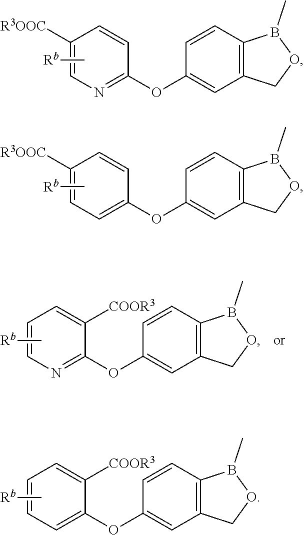

In another embodiment, at least one of R^{A} and R^{B} has a structure selected from:

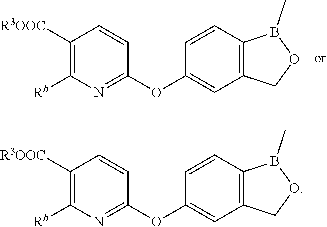

In another embodiment, at least one of R^{A} and R^{B} has a structure selected from:

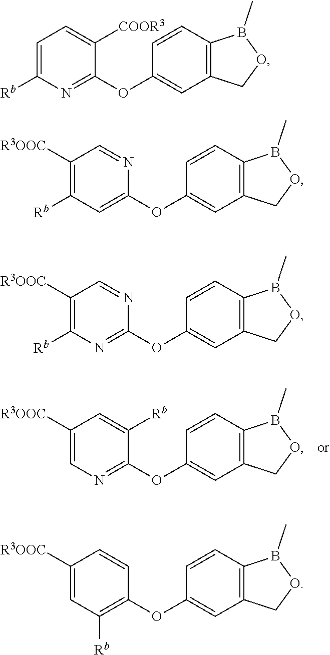

In another embodiment when at least one of R^{A} and R^{B} has a structure of formula (G), R⁹ is —CONR¹R² and R¹⁰ is R^{b}.

In another embodiment, each of R^{A} and R^{B} is independently selected from formula (B), (C), (D), (E), (F), or (G).

In another embodiment, the volatile compound of the invention is selected from:

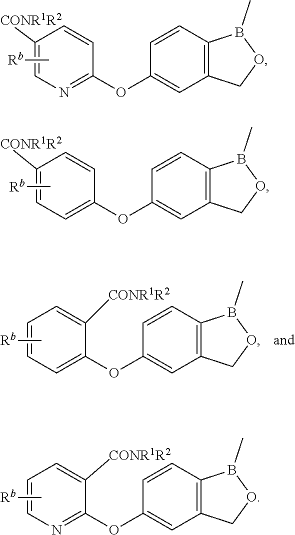

In another embodiment, the volatile compound of the invention is selected from:

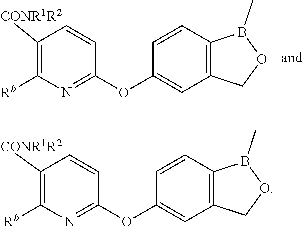

In another embodiment, the volatile compound of the invention is selected from:

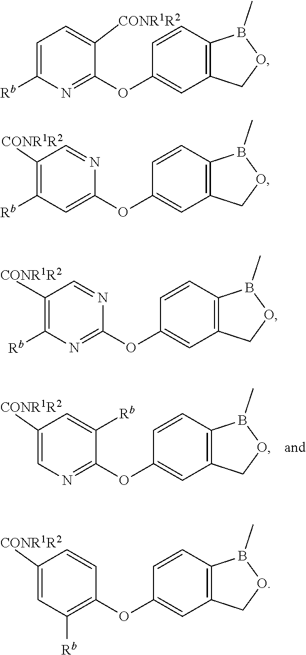

In one embodiment, R^{b} is selected from fluorine and chlorine. In another embodiment, R^{b} is selected from OR²⁰ and NR²¹R²². In another embodiment when R^{b} is OR²⁰, R²⁰ is selected from H, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. In another embodiment when R^{b} is OR²⁰, R²⁰ is selected from H, substituted or unsubstituted alkyl, substituted or unsubstituted heteroalkyl and substituted or unsubstituted cycloalkyl. In another embodiment when R^{b} is OR²⁰, R²⁰ is unsubstituted C₁₋₆ alkyl. In another embodiment when R^{b} is OR²⁰, R²⁰ is unsubstituted cycloalkyl. In another embodiment when R^{b} is OR²⁰, R²⁰ is alkyl, substituted with a member selected from substituted or unsubstituted C₁₋₆ alkoxy. In another embodiment when R^{b} is OR²⁰, R²⁰ is alkyl, substituted with at least one halogen. In another embodiment when R^{b} OR²⁰, R²⁰ is alkyl, substituted with at least one oxo moiety.

In another embodiment when R^{b} is OR²⁰, R²⁰ is a member selected from —CH₃, —CH₂CH₃, —(CH₂)₂CH₃, —CH(CH₃)₂, —CH₂CF₃, —CH₂CHF₂, —CH₂CH₂(OH), —CH₂CH₂(OCH₃), —CH₂CH₂(OC(CH₃)₂), —C(O)CH₃, —CH₂CH₂OC(O)CH₃, —CH₂C(O)OCH₂CH₃, —CH₂C(O)OC(CH₃)₃, —(CH₂)₃C(O)CH₃, —CH₂C(O)OC(CH₃)₃, cyclopentyl, cyclohexyl,

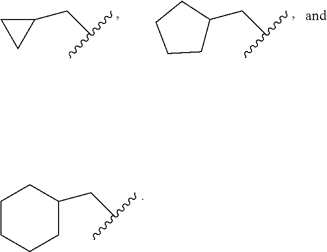 [SMILES: *CC1CC1 ; *CC1CCCC1 ; *CC1CCCCC1]

In another embodiment when R^{b} is NR²¹R²², R²¹ and R²² are members independently selected from H, substituted or unsubstituted alkyl, substituted or unsubstituted heteroalkyl, substituted or unsubstituted cycloalkyl, substituted or unsubstituted heterocycloalkyl, substituted or unsubstituted aryl, and substituted or unsubstituted heteroaryl. In another embodiment when R^{b} is NR²¹R²², R²¹ is H or unsubstituted alkyl; and R²² is unsubstituted alkyl or alkyl substituted with a member selected from hydroxyl, phenyl, unsubstituted alkoxy and alkoxy substituted with a phenyl. In a further embodiment when R^{b} is NR²¹R²², R²¹ is H or CH₃.

In another embodiment when R^{b} is NR²¹R²², R²¹ and R²² are independently selected from substituted or unsubstituted alkyl. In another embodiment when R^{b} is NR²¹R²², R²¹ is unsubstituted alkyl; and R²² is substituted or unsubstituted alkyl. In another embodiment when R^{b} is NR²¹R²², R²¹ is unsubstituted alkyl; and R²² is alkyl, substituted with a member selected from substituted or unsubstituted alkoxy and hydroxyl. In another embodiment when R^{b} is NR²¹R²², R²¹ is unsubstituted alkyl; and R²² is alkyl, substituted with unsubstituted alkoxy. In another embodiment when R^{b} is NR²¹R²², R²¹ is unsubstituted alkyl; and R²² is alkyl, substituted with alkoxy, substituted with phenyl. In another embodiment when R^{b} is NR²¹R²², R²¹ is unsubstituted alkyl; and R²² is alkyl, substituted with unsubstituted alkoxy. In another embodiment when R^{b} is NR²¹R²², R²¹ and R²² together with the nitrogen to which they are attached, are combined to form a 4- to 8-membered substituted or unsubstituted heterocycloalkyl ring. In another embodiment when R^{b} is NR²¹R²², R²¹ and R²² together with the nitrogen to which they are attached, are combined to form a 5- or 6-membered substituted or unsubstituted heterocycloalkyl ring.

In another embodiment, R^{b} is selected from N(CH₃)₂, N(CH₃)(CH₂CH₂(OCH₃)), N(CH₃)(CH₂CH₂OH), NH₂, NHCH₃, NH(CH₂CH₂(OCH₃)), NH(CH₂CH₂(OCH₂Ph), NH(CH₂Ph), NH(C(CH₃)₃) and NH(CH₂CH₂OH). In another embodiment, R^{b} is selected from

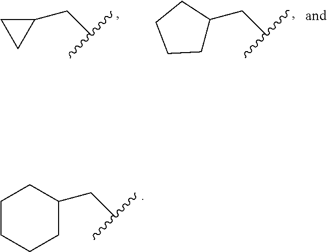 [SMILES: *CC1CC1 ; *CC1CCCC1 ; *CC1CCCCC1]

Additional oxaborole moieties are also disclosed previously in U.S. Pat. No. 8,039,450, and U.S. Patent Application Publication No. 2009/0291917, the contents of which are hereby incorporated by reference in their entireties.

In another embodiment, the compound provided has a structure of formula (A1) or (A2):

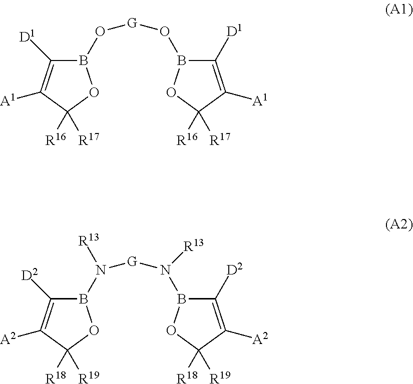

wherein each of A¹, A², D¹, and D² is independently hydrogen, substituted or unsubstituted C₁₋₁₈-alkyl, arylalkyl, aryl, or heterocyclic; or A¹ and D¹, or A² and D² together form a 5, 6, or 7-membered fused ring which is substituted or unsubstituted;

each of R¹³, R¹⁶, R¹⁷, R¹⁸, and R¹⁹ is independently hydrogen, substituted or unsubstituted C₁₋₆-alkyl, nitrile, nitro, aryl or aryl alkyl; or R¹⁶ and R¹⁷, or R¹⁸ and R¹⁹ together form an alicyclic ring which is substituted or unsubstituted;

B is boron; and

G is a substituted or unsubstituted C₁₋₁₈-alkylene, arylalkylene, arylene, or heterocyclic moiety.

In another embodiment, each of R^{A} and R^{B} is independently

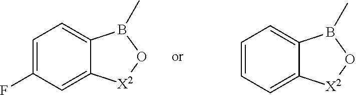

wherein X²═(CR⁶₂)ₘ and m=1, 2, 3, or 4.

In another embodiment, each of R^{A} and R^{B} is independently

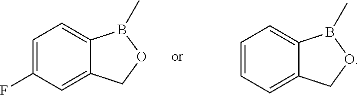

Meats, plants, or plant parts may be treated in the practice of the present invention. One example is treatment of whole plants; another example is treatment of whole plants while they are planted in soil, prior to the harvesting of useful plant parts.

Any plants that provide useful plant parts may be treated in the practice of the present invention. Examples include plants that provide flowers, fruits, vegetables, and grains.

As used herein, the phrase “plant” includes dicotyledonous plants and monocotyledonous plants. Examples of dicotyledonous plants include tobacco, Arabidopsis, soybean, tomato, papaya, canola, sunflower, cotton, alfalfa, potato, grapevine, pigeon pea, pea, Brassica, chickpea, sugar beet, rapeseed, watermelon, melon, pepper, peanut, pumpkin, radish, spinach, squash, broccoli, cabbage, carrot, cauliflower, celery, Chinese cabbage, cucumber, eggplant, and lettuce. Examples of monocotyledonous plants include corn, rice, wheat, sugarcane, barley, rye, sorghum, orchids, bamboo, banana, cattails, lilies, oat, onion, millet, and triticale. Examples of fruit include banana, pineapple, oranges, grapes, grapefruit, watermelon, melon, apples, peaches, pears, kiwifruit, mango, nectarines, guava, persimmon, avocado, lemon, fig, and berries. Examples of flowers include baby's breath, carnation, dahlia, daffodil, geranium, gerbera, lily, orchid, peony, Queen Anne's lace, rose, snapdragon, or other cut-flowers or ornamental flowers, potted-flowers, and flower bulbs.

In some embodiments, the meats, plants, or plant parts are selected from the group consisting of barley, camphor tree, canola, castor-oil plant, cinnamon, cocoa, coffee, corn, cotton, flax, grapevine, hemp, hops, jute, maize, mustard, nuts, oat, poppy, rape, rice, rubber plant, rye, sunflower, sorghum, soybean, sugar cane, tea, tobacco, wheat, and a combination thereof. In some embodiments, the meats, plants, or plant parts are selected from the group consisting of almond, apple, avocado, banana, berry, carambola, cherry, citrus, coconut, fig, grapes, guava, kiwifruit, mango, nectarine, melons, olive, papaya, passionfruit, peach, pear, persimmon, pineapple, plum, pomegranate, and a combination thereof.

In some embodiments, the berries are selected from the group consisting of strawberry, blueberry, raspberry, blackberry, and currents, and a combination thereof.

In some embodiments, the citrus is selected from the group consisting of oranges, lemon, lime, mandarin, grapefruit, and a combination thereof.

In some embodiments, the melons are selected from the group consisting of cantaloupe, muskmelon, watermelon, and a combination thereof.

In some aspects, a compound in accordance with the present disclosure has a Minimum Inhibitory Concentration (MIC) towards a microorganism. In some embodiments, the MIC is less than about 80 mg/L, less than about 60 mg/L, less than about 40 mg/L, less than about 30 mg/L, less than about 20 mg/L, less than about 10 mg/L, less than about 8 mg/L, less than about 5 mg/L, less than about 4 mg/L, less than about 3 mg/L, less than about 2 mg/L, less than about 1 mg/L, less than about 0.5 mg/L, less than about 0.4 mg/L, or less than about 0.3 mg/L. In some embodiments, a compound has an MIC in a range of about 0.05 mg/L to about 80 mg/L, about 0.05 mg/L to about 40 mg/L, about 0.05 mg/L to about 20 mg/L, about 0.1 mg/L to about 20 mg/L, about 0.1 mg/L to about 10 mg/L, about 0.1 mg/L to about 5 mg/L, about 0.1 mg/L to about 4 mg/L, or about 0.1 mg/L to about 3 mg/L.

In some aspects, a compound in accordance with the present disclosure is has a half maximal effective concentration (EC₅₀) towards a microorganism. In some embodiments, the EC₅₀ is less than about 40 mg/L, less than about 30 mg/L, less than about 20 mg/L, less than about 10 mg/L, less than about 8 mg/L, less than about 5 mg/L, less than about 4 mg/L, less than about 3 mg/L, less than about 2 mg/L, less than about 1 mg/L, less than about 0.5 mg/L, less than about 0.4 mg/L, or less than about 0.3 mg/L. In some embodiments, a compound has an EC₅₀ in a range of about 0.05 mg/L to about 40 mg/L, about 0.05 mg/L to about 20 mg/L, about 0.05 mg/L to about 10 mg/L, about 0.1 mg/L to about 10 mg/L, about 0.1 mg/L to about 5 mg/L, about 0.1 mg/L to about 4 mg/L, or about 0.1 mg/L to about 3 mg/L.

In some aspects, a compounds in accordance with the present disclosure can be prepared by a process according to Scheme 1.

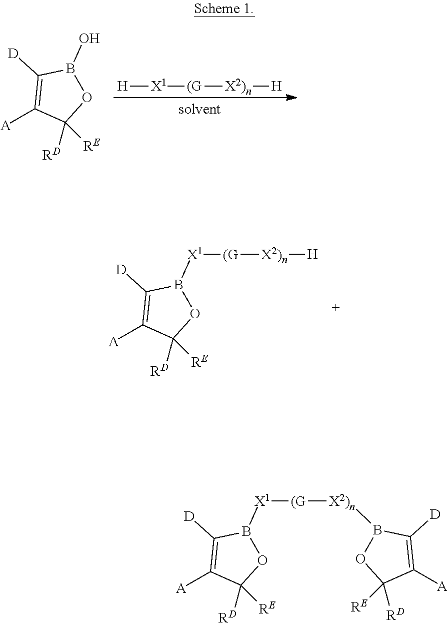

wherein A, D, R^{D}, R^{E}, and (H)—X¹-(G-X²)n-(H) are defined as described above. Illustratively, Scheme 1 includes mixing at least one oxaborole compound with at least one adducting compound, in a first organic solvent. Illustratively, the at least one adducting compound comprises a diol or diamine compound as described herein. In some embodiments, the method further includes evaporating the first organic solvent by heating, thereby allowing the at least one adducting compound to react with the at least one oxaborole compound to generate at least one adducted product.

In some embodiments, the mixing step is performed in the presence of at least one catalyst. In a further embodiment, the catalyst is selected from the group consisting of amine, phosphine, heterocyclic nitrogen, ammonium, phosphonium, arsonium, sulfonium moieties, and combinations thereof. In another embodiment, the catalyst is selected from the group consisting of a phosphonium compound, an ammonium compound, chromium salts, amino compounds and combinations thereof. In another embodiment, the catalyst is selected from the group consisting of 2-methyl imidazole, 2-phenyl imidazole, an imidazole derivative, 1,8-diazabicyclo[5.4.0] undec-7-ene (DBU), and combinations thereof.

In some embodiments, the first organic solvent is a non-polar solvent. In some embodiments, the non-polar solvent is an aromatic solvent. Illustrative aromatic solvents include toluene and xylene.

In some embodiments, the second organic solvent is a non-polar solvent. In some embodiments, the non-polar solvent is an aromatic solvent. Illustrative aromatic solvents include toluene and xylene. In some embodiments, the non-polar solvent is an aliphatic solvent. Illustrative aliphatic solvents include pentane, hexane, and heptane.

Those skilled in the art would understand certain variation can exist based on the disclosure provided. Thus, the following examples are given for the purpose of illustrating the invention and shall not be construed as being a limitation on the scope of the invention or claims.

The description of additional compounds, experiments, and results can be found in U.S. Patent Application Publication No. 2017-0164615, hereby incorporated by reference in its entirety.

### Examples

### Comparative Example 1—Preparation of Compound 7 (1,2-bis((5-fluorobenzo[c][1,2]oxaborol-1(3H)-yl)oxy)ethane)

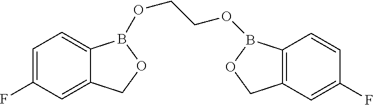 [SMILES: Fc1ccc2c(c1)COB2OCCOB1OCc2cc(F)ccc21]

3.20 g of 5-fluoro-1,3-dihydro-1-hydroxy-2,1-benzoxaborole (21.2 mmol) and 3.20 g of ethylene glycol (51.6 mmol) are heated in 40 g of toluene. The toluene-water azeotrope is distilled out of the system until the head temperature reached 110° C. The toluene is removed via rotary evaporator and the excess ethylene glycol is removed by kugelrohr distillation at about 20 torr and 100° C. bath temperature. Recrystallization from toluene generates 2.95 g of white crystals, mp 145-149° C. Proton nmr shows spectra and integration consistent with the two to one product.

### Comparative Example 2—Preparation of Compound 1 (1,2-bis(benzo[c][1,2]oxaborol-1(3H)-yloxy)ethane)

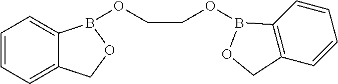 [SMILES: c1ccc2c(c1)COB2OCCOB1OCc2ccccc21]

3.00 g of 1,3-dihydro-1-hydroxy-2,1-benzoxaborole (22.4 mmol) and 3.00 g of ethylene glycol (46.9 mmol) are heated in 40 g of toluene. The toluene-water azeotrope is distilled out of the system until the head temperature reached 110° C. The toluene is removed via rotary evaporator and the excess ethylene glycol is removed by kugelrohr distillation at about 20 torr and 100° C. bath temperature. Recrystallization from toluene generates 2.49 g of white crystals, mp 118-120.5° C. Proton NMR shows spectra and integration consistent with the two to one product.

### Comparative Example 3—Preparation of Compound 9 (1,1′-((2,3-dimethylbutane-2,3-diyl)bis(oxy))bis(5-fluoro-1,3-dihydrobenzo[c][1,2]oxaborole)

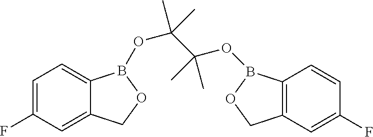 [SMILES: CC(C)(OB1OCc2cc(F)ccc21)C(C)(C)OB1OCc2cc(F)ccc21]

3.17 g of 5-fluoro-1,3-dihydro-1-hydroxy-2,1-benzoxaborole (21.0 mmol) and 3.22 g of pinacol (27.3 mmol) are heated in 40 g of toluene. The toluene-water azeotrope is distilled out of the system until the head temperature reached 110° C. The toluene is removed via rotary evaporator and the excess pinacol is removed by kugelrohr distillation at about 20 torr and 120° C. bath temperature. Recrystallization from hexane generates 3.21 g of white crystals, mp 81-89° C. Proton NMR shows spectra and integration consistent with the two to one product.

### Comparative Example 4—Preparation of Compound 13 (1,3-bis((5-fluorobenzo[c][1,2]oxaborol-1(3H)-yl)oxy)propane)

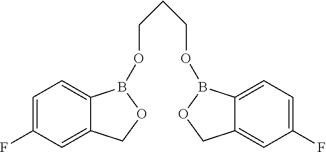 [SMILES: Fc1ccc2c(c1)COB2OCCCOB1OCc2cc(F)ccc21]

3.0 g of 5-fluoro-1,3-dihydro-1-hydroxy-2,1-benzoxaborole (19.9 mmol) and 2.5 g of 1,2-propanediol (propylene glycol; 32.9 mmol) are heated in 40 g of toluene. The toluene-water azeotrope is distilled out of the system until the head temperature reached 110° C. The toluene is removed via rotary evaporator and the excess propylene glycol is removed by kugelrohr distillation at about 20 torr and 110° C. bath temperature. Recrystallization from hexane generates 3.49 g of white crystals, mp 65.5-68.5° C. Proton NMR shows spectra and integration consistent with the two to one product.

The remaining compounds shown in the below table were prepared in analogous manner to those prepared in Examples 1-4.

### Representative Embodiments

| Compound | | |
|---|---|---|
| Number | Structure | Name |
| 1 | 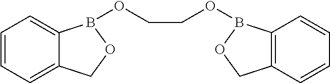 [SMILES: c1ccc2c(c1)COB2OCCOB1OCc2ccccc21] | 1,2-bis(benzo[c][1,2]oxaborol- 1(3H)-yloxy)ethane |
| 2 | 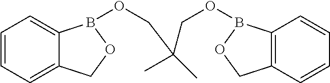 [SMILES: CC(C)(COB1OCc2ccccc21)COB1OCc2ccccc21] | 1,1′-((2,2-dimethylpropane-1,3- diyl)bis(oxy))bis(1,3- dihydrobenzo[c][1,2]oxaborole) |
| 3 | 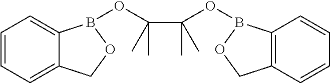 [SMILES: CC(C)(OB1OCc2ccccc21)C(C)(C)OB1OCc2ccccc21] | 1,1′-((2,3-dimethylbutane-2,3- diyl)bis(oxy))bis(1,3- dihydrobenzo[c][1,2]oxaborole) |
| 4 | 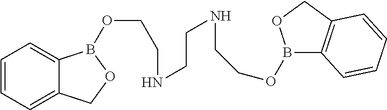 [SMILES: c1ccc2c(c1)COB2OCCNCCNCCOB1OCc2ccccc21] | N¹,N²-bis(2- (benzo[c][1,2]oxaborol-1(3H)- yloxy)ethyl)ethane-1,2-diamine |
| 5 | 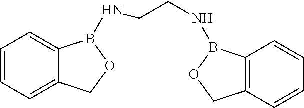 [SMILES: c1ccc2c(c1)COB2NCCNB1OCc2ccccc21] | N¹,N²- bis(benzo[c][1,2]oxaborol- 1(3H)-yl)ethane-1,2-diamine |
| 6 | 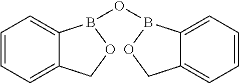 [SMILES: c1ccc2c(c1)COB2OB1OCc2ccccc21] | 1,1′-oxybis(1,3- dihydrobenzo[c][1,2]oxaborole) |
| 7 | 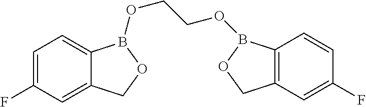 [SMILES: Fc1ccc2c(c1)COB2OCCOB1OCc2cc(F)ccc21] | 1,2-bis((5- fluorobenzo[c][1,2]oxaborol- 1(3H)-yl)oxy)ethane |
| 8 | 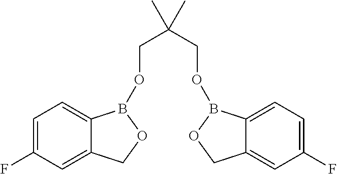 [SMILES: CC(C)(COB1OCc2cc(F)ccc21)COB1OCc2cc(F)ccc21] | 1,1′-((2,2-dimethylpropane-1,3- diyl)bis(oxy))bis(5-fluoro-1,3- dihydrobenzo[c][1,2]oxaborole) |
| 9 | 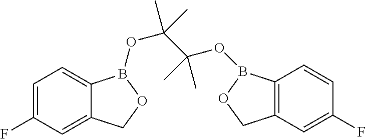 [SMILES: CC(C)(OB1OCc2cc(F)ccc21)C(C)(C)OB1OCc2cc(F)ccc21] | 1,1′-((2,3-dimethylbutane-2,3- diyl)bis(oxy))bis(5-fluoro-1,3- dihydrobenzo[c][1,2]oxaborole) |
| 10 | 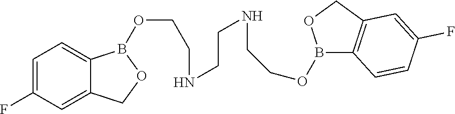 [SMILES: Fc1ccc2c(c1)COB2OCCNCCNCCOB1OCc2cc(F)ccc21] | N¹,N²-bis(2-((5- fluorobenzo[c][1,2]oxaborol- 1(3H)-yl)oxy)ethyl)ethane-1,2- diamine |
| 11 | 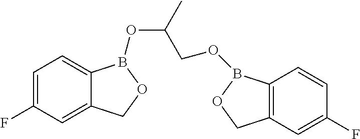 [SMILES: CC(COB1OCc2cc(F)ccc21)OB1OCc2cc(F)ccc21] | 1,1′-(propane-1,2- diylbis(oxy))bis(5-fluoro-1,3- dihydrobenzo[c][1,2]oxaborole) |
| 12 | 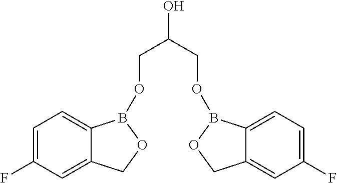 [SMILES: OC(COB1OCc2cc(F)ccc21)COB1OCc2cc(F)ccc21] | 1,3-bis((5- fluorobenzo[c][1,2]oxaborol- 1(3H)-yl)oxy)propan-2-ol |
| 13 | 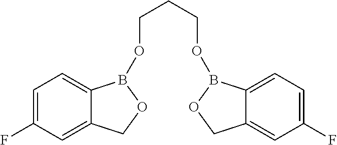 [SMILES: Fc1ccc2c(c1)COB2OCCCOB1OCc2cc(F)ccc21] | 1,3-bis((5- fluorobenzo[c][1,2]oxaborol- 1(3H)-yl)oxy)propane |
| 14 | 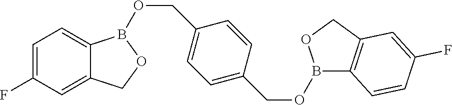 [SMILES: Fc1ccc2c(c1)COB2OCc1ccc(COB2OCc3cc(F)ccc32)cc1] | 1,4-bis(((5- fluorobenzo[c][1,2]oxaborol- 1(3H)-yl)oxy)methyl)benzene |
| 15 | 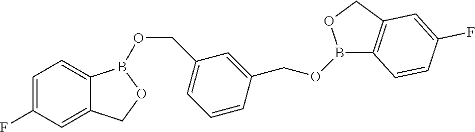 [SMILES: Fc1ccc2c(c1)COB2OCc1cccc(COB2OCc3cc(F)ccc32)c1] | 1,3-bis(((5- fluorobenzo[c][1,2]oxaborol- 1(3H)-yl)oxy)methyl)benzene |
| 16 | 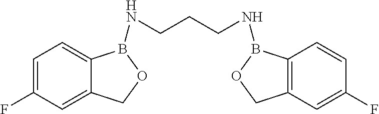 [SMILES: Fc1ccc2c(c1)COB2NCCCNB1OCc2cc(F)ccc21] | N¹,N³-bis(5- fluorobenzo[c][1,2]oxaborol- 1(3H)-yl)propane-1,3-diamine |
| 17 | 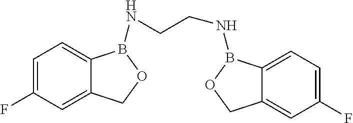 [SMILES: Fc1ccc2c(c1)COB2NCCNB1OCc2cc(F)ccc21] | N¹,N²-bis(5- fluorobenzo[c][1,2]oxaborol- 1(3H)-yl)ethane-1,2-diamine |
| 18 | 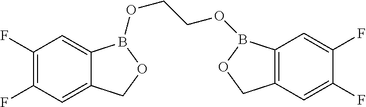 [SMILES: Fc1cc2c(cc1F)B(OCCOB1OCc3cc(F)c(F)cc31)OC2] | 1,2-bis((5,6- difluorobenzo[c][1,2]oxaborol- 1(3H)-yl)oxy)ethane |
| 19 | 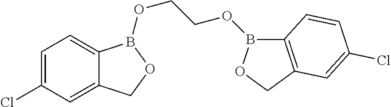 [SMILES: Clc1ccc2c(c1)COB2OCCOB1OCc2cc(Cl)ccc21] | 1,2-bis((5- chlorobenzo[c][1,2]oxaborol- 1(3H)-yl)oxy)ethane |
| 20 | 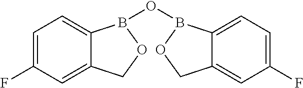 [SMILES: Fc1ccc2c(c1)COB2OB1OCc2cc(F)ccc21] | 1,1′-oxybis(5-fluoro-1,3- dihydrobenzo[c][1,2]oxaborole) |

### Example 5—In Vitro Analysis

12-well (6.5 ml volume per well) microtiter plates are used for the in vitro inhibition assay for volatile antimicrobial compounds. A 3-ml volume of full-strength Potato Dextrose Agar (PDA) is added to each well. After cooling, 1 μL of 1×10⁵ spores per ml Botrytis cinerea (ATCC #204446) spore suspension is spot pipetted to the agar in the center of the well.

Whatman #1 filter disks (1.5 cm; Cat. No. 1001-0155) are placed on the underside of a polyethylene PCR plate sealing film. For determination of the minimum inhibitory concentration (MIC), test compounds are diluted in acetone, in duplicate, and 50 μli of the compound solution is added to disks at concentrations that can vary from 0.001 mg/l to 1142.9 mg/l.

The acetone is permitted to evaporate for 5 minutes. The headspace around the Botrytis cinerea inoculum is then sealed inside the well by the film with the adhering disk containing the antimicrobial, anti-decay, anti-spoilage, or pathogen control agent. Plates are inverted to prevent any possibility of the chemical from flaking from the disk and falling onto the inoculated agar. After 3 days of incubation at 23° C., cultures are evaluated for percent growth relative to control and determination of MIC. Samples 1-4 show good antimicrobial activity against Botrytis cinerea and/or other pathogens in this in vitro analysis. EC₅₀ values are shown in Table 1. Minimum inhibitory concentrations (MIC) are shown in Table 2.

TABLE 1
EC50 values

| | EC50 mg/L | | | | |
|---|---|---|---|---|---|
| Compound | Botrytis | Penicillium | Alternaria | Monilinia | Glomerella |
| # | cinerea | expansum | alternata | fructicola | cingulata |
| 1 | 0.9 | 2.5 | <0.6 | 6.8 | 11.1 |
| 2 | 1.4 | 12.2 | 2.3 | 7.2 | 9.1 |
| 3 | 2.1 | 11.1 | — | — | — |
| 4 | 0.4 | 2 | — | — | — |
| 5 | 0.9 | 3.3 | — | — | — |
| 6 | 0.8 | 3.1 | — | — | — |
| 7 | 0.2 | <0.6 | 0.3 | — | — |
| 8 | 0.3 | 0.8 | — | — | — |
| 9 | 0.3 | 0.8 | 0.3 | — | — |
| 10 | 0.2 | 0.9 | — | — | — |
| 11 | 0.2 | <0.6 | 0.31 | 0.2 | — |
| 12 | 0.2 | 1.1 | — | — | — |
| 13 | 0.1 | 0.8 | — | — | — |
| 14 | 0.4 | 1.7 | — | — | — |
| 15 | 0.7 | 2.5 | — | — | — |
| 16 | 0.3 | 1.0 | — | — | — |
| 17 | 0.4 | 1.8 | — | — | — |
| 18 | 3 | >35.7 | — | — | — |
| 19 | 0.0 | — | — | — | — |
| 20 | 0.1 | 0.5 | — | — | — |

TABLE 2
MIC values

| | MIC mg/L | | | | |
|---|---|---|---|---|---|
| Compound | Botrytis | Penicillium | Alternaria | Monilinia | Glomerella |
| # | cinerea | expansum | alternata | fructicola | cingulata |
| 1 | 2.2 | 8.9 | 8.9 | 35.7 | 142.9 |
| 2 | 4.5 | 71.4 | 8.9 | 17.9 | 142.9 |
| 3 | 8.9 | 71.4 | — | — | — |
| 4 | 1.1 | 8.9 | — | — | — |
| 5 | 4.5 | 17.9 | — | — | — |
| 6 | 2.2 | 17.9 | — | — | — |
| 7 | 0.6 | 8.9 | 2.2 | 2.2 | — |
| 8 | 0.6 | 2.2 | — | — | — |
| 9 | 1.1 | 4.5 | 2.2 | — | — |
| 10 | 0.6 | 8.9 | — | — | — |
| 11 | 0.6 | 8.9 | 1.1 | — | — |
| 12 | 0.6 | 8.9 | — | — | — |
| 13 | 0.3 | 8.9 | — | — | — |
| 14 | 1.1 | 17.9 | — | — | — |
| 15 | 2.2 | 17.9 | | | |
| 16 | 1.1 | 8.9 | — | — | — |
| 17 | 1.1 | 17.9 | — | — | — |
| 18 | 9 | >35.7 | — | — | — |
| 19 | 0 | — | — | — | — |
| 20 | 0.3 | 4.5 | — | — | — |

### Example 6—Grape In Vivo Analysis

In order to assess the in vivo activity of volatile antimicrobial compounds, a volatile bioassay is developed using green table grape. Fruit are removed from the rachis, and 16 to 20 fruit are placed inside a 1 dry pint clamshell (Produce Packaging; Product #03231004KZ) with the stem wound facing upwards. The grapes are inoculated by pipetting 20 μL of 1×10⁶ spore per ml Botrytis cinerea (ATCC #204446) into the stem wound. The clamshell is placed inside a 2.55 L plastic container (Snapware; Model #1098421). A Whatman #1 filter paper (4.25 cm; Cat. No. 1001-042) is placed on a watchglass, which is then placed on top of the closed clamshell lid. For determination of the MIC, test compounds are diluted in acetone, and 400 μl of the solution is added to disks, in duplicate, in a dose dependent manner (for example 0.4 to 50 mg/liter). The acetone is permitted to evaporate for 5 minutes. The plastic containers are then closed and placed for 3 days at 21° C. Clamshells are then removed from the treatment plastic container and placed into separate larger secondary containers for a further 3 days of evaluation at 21° C. During these 3 days, fruit are evaluated daily for incidence and severity of disease and symptoms of phytotoxicity. Compounds 1, 7, 9, and 13 show good antimicrobial activity against Botrytis cinerea in this in vivo analysis and no phytotoxicity.

### Example 7—Strawberry In Vivo Analysis

In order to assess the in vivo activity of volatile antimicrobial compounds, a volatile bioassay is developed using strawberry. Fruit (6 to 8) are placed inside a 1 lb clamshell (Packaging Direct Inc.; Product #4341699) with the calyx facing downward. The strawberry fruit are wound-inoculated by pipetting 20 μL of 1×10⁶ spore per ml Botrytis cinerea (ATCC #204446) into a wound approximately 5 mm deep and 2.6 mm in width. The clamshell is placed inside a 2.55 L plastic container (Snapware; Model #1098421). A Whatman #1 filter paper (4.25 cm; Cat. No. 1001-042) is placed on a watchglass, which is then placed on top of the closed clamshell lid. For determination of the MIC, test compounds are diluted in acetone, and 400 μl of the solution is added to disks, in duplicate, in a dose dependent manner (for example 0.4 to 50 mg/liter). The acetone is permitted to evaporate for 5 minutes. The plastic containers are then closed and placed for 3 days at 21° C. Clamshells are then removed from the treatment plastic container and placed into separate larger secondary containers for a further 3 days of evaluation at 21° C. During these 3 days, fruit are evaluated daily for incidence and severity of disease and symptoms of phytotoxicity. Compounds 1, 7, 9, and 13 show good antimicrobial activity against Botrytis cinerea in this in vivo analysis and no phytotoxicity.

### Example 8—Antimicrobial Activity Against Bacteria

12-well (6.5 ml volume per well) microtiter plates are used for the in vitro inhibition assay for volatile antimicrobial compounds. A 3-ml volume of full-strength L^{B} Agar is added to each well. After cooling, 15 μL of Escherichia coli (ATCC #25922) adjusted to an optical density of 0.02 to 0.035, and further diluted 1/10 is pipetted to the center of the agar. The plate is tilted to distribute bacteria uniformly. Whatman #1 filter disks (1.5 cm; Cat. No. 1001-0155) are placed on the underside of a polyethylene PCR plate sealing film. For determination of the minimum inhibitory concentration (MIC), test compounds are diluted in acetone, in duplicate, and 50 μl of compound is added to disks at concentrations that can vary from 0.015 to 35.7 mg/l. The acetone is permitted to evaporate for 5 minutes. The headspace around the Escherichia coli inoculum is then sealed inside the well by the film with the adhering disk containing the antimicrobial, anti-decay, anti-spoilage, or pathogen control agent. Plates are inverted, placed over the treated disks and sealed to prevent any of the chemical from flaking from the disk and falling onto the inoculated agar. After 2 days of incubation at 23° C., cultures were evaluated for colony growth relative to control. Compounds 1, 7, 9, and 13 show good antimicrobial activity against Escherichia coli in this in vitro analysis.

We claim:

1. A compound having a structure of formula (A):
R^{A}—X¹-(G-X²)ₙ—R^{B} (A)
wherein,
each of R^{A} and R^{B} is independently an oxaborole;
X¹ and each X² are independently O, NH, or S;
each G is independently aryl, heteroaryl, arylalkyl, alkylarylalkyl, or C₁-C₈ alkyl, wherein each hydrogen atom in aryl, heteroaryl, arylalkyl, alkylarylalkyl, or C₁-C₈ alkyl is independently optionally substituted by deuterium, halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;
each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F; and
n=0 to 4,
and agriculturally acceptable salts thereof, provided the compound is not

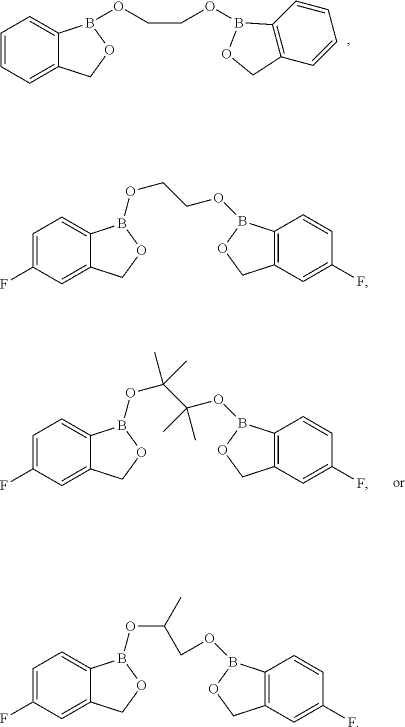 [SMILES: c1ccc2c(c1)COB2OCCOB1OCc2ccccc21 ; Fc1ccc2c(c1)COB2OCCOB1OCc2cc(F)ccc21 ; CC(C)(OB1OCc2cc(F)ccc21)C(C)(C)OB1OCc2cc(F)ccc21 ; CC(COB1OCc2cc(F)ccc21)OB1OCc2cc(F)ccc21]

2. The compound of claim 1, wherein each G is independently aryl, heteroaryl, arylalkyl, alkylarylalkyl, or C₁-C₈ alkyl and wherein each hydrogen atom in aryl, heteroaryl, arylalkyl, alkylarylalkyl, or C₁-C₈ alkyl is independently optionally substituted by halogen, —OH, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —C₁-C₆ alkyl, —C₂-C₆ alkenyl, —C₂-C₆ alkynyl, —C₃-C₆ cycloalkyl, or 3-to 7-membered heterocycloalkyl, and
each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F,
and agriculturally acceptable salts thereof.

3. The compound of claim 1, wherein each G is independently aryl, heteroaryl, arylalkyl, alkylarylalkyl, or C₁-C₈ alkyl and wherein each hydrogen atom in aryl, heteroaryl, arylalkyl, alkylarylalkyl, or C₁-C₈ alkyl is independently optionally substituted by halogen, —OH, —OR¹, —C₁-C₆ alkyl, —C₂-C₆ alkenyl, —C₂-C₆ alkynyl, —C₃-C₆ cycloalkyl, or 3-to 7-membered heterocycloalkyl, and
each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F,
and agriculturally acceptable salts thereof.

4. The compound of claim 1, wherein G is C₁-C₈ alkyl, and wherein at least one hydrogen in C₁-C₈ alkyl is substituted by halogen, —OH, —CN, —OR¹, —NH₂, —NH(C₁-C₆ alkyl), —N(C₁-C₆ alkyl)₂, —NHC(O)C₁-C₆ alkyl, —N(C₁-C₆ alkyl)C(O)C₁-C₆ alkyl, —NHC(O)NH₂, —NHC(O)NHC₁—C₆ alkyl, —N(C₁-C₆ alkyl)C(O)NH₂, —N(C₁-C₆ alkyl)C(O)NHC₁—C₆ alkyl, —NHC(O)N(C₁-C₆ alkyl)₂, —N(C₁-C₆ alkyl)C(O)N(C₁-C₆ alkyl)₂, —NHC(O)OC₁—C₆ alkyl, —N(C₁-C₆ alkyl)C(O)OC₁—C₆ alkyl, —NHS(O)(C₁-C₆ alkyl), —NHS(O)₂(C₁-C₆ alkyl), —N(C₁-C₆ alkyl)S(O)(C₁-C₆ alkyl), —N(C₁-C₆ alkyl)S(O)₂(C₁-C₆ alkyl), —NHS(O)NH₂, —NHS(O)₂NH₂, —N(C₁-C₆ alkyl)S(O)NH₂, —N(C₁-C₆ alkyl)S(O)₂NH₂, —NHS(O)NH(C₁-C₆ alkyl), —NHS(O)₂NH(C₁-C₆ alkyl), —NHS(O)N(C₁-C₆ alkyl)₂, —NHS(O)₂N(C₁-C₆ alkyl)₂, —N(C₁-C₆ alkyl)S(O)NH(C₁-C₆ alkyl), —N(C₁-C₆ alkyl)S(O)₂NH(C₁-C₆ alkyl), —N(C₁-C₆ alkyl)S(O)N(C₁-C₆ alkyl)₂, —N(C₁-C₆ alkyl)S(O)₂N(C₁-C₆ alkyl)₂, —CO₂H, —C(O)OC₁—C₆ alkyl, —C(O)NH₂, —C(O)NH(C₁-C₆ alkyl), —C(O)N(C₁-C₆ alkyl)₂, —SC₁—C₆ alkyl, —S(O)C₁-C₆ alkyl, —S(O)₂C₁-C₆ alkyl, —S(O)NH(C₁-C₆ alkyl), —S(O)₂NH(C₁-C₆ alkyl), —S(O)N(C₁-C₆ alkyl)₂, —S(O)₂N(C₁-C₆ alkyl)₂, C₁-C₆ alkyl, C₂-C₆ alkenyl, C₂-C₆ alkynyl, C₃-C₆ cycloalkyl, 3-to 7-membered heterocycloalkyl, C₁-C₆ alkyl-(3-to 7-membered heterocycloalkyl), —CF₃, —CHF₂, or —CH₂F;
wherein each R¹ is independently deuterium, C₁-C₆ alkyl, C₂-C₆ alkenyl, C₂-C₆ alkynyl, C₃-C₆ cycloalkyl, 3- to 7-membered heterocycloalkyl, C₆-C₁₀ aryl, heteroaryl, —CF₃, —CHF₂, or —CH₂F,
and agriculturally acceptable salts thereof.

5. The compound of claim 4, wherein at least one hydrogen in C₁-C₈ alkyl is substituted by halogen, —OH, —C₁-C₆ alkyl, or —OR¹, wherein each R¹ is independently deuterium or —C₁-C₆ alkyl,
and agriculturally acceptable salts thereof.

6. The compound of claim 4, wherein at least one hydrogen in C₁-C₈ alkyl is substituted by —OH or —C₁-C₆ alkyl,
and agriculturally acceptable salts thereof.

7. The compound of claim 1, wherein X¹-(G-X²)ₙ is of the formula 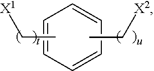
wherein t and u are each independently an integer from 0 to 6,
and agriculturally acceptable salts thereof.

8. The compound of claim 7, wherein each of t and u are an integer from 1 to 6,
and agriculturally acceptable salts thereof.

9. The compound of claim 8, wherein X¹ and each X² are independently O or NH,
and agriculturally acceptable salts thereof.

10. The compound of claim 1, wherein X is O and n=2 to 4,
and agriculturally acceptable salts thereof.

11. The compound of claim 10, wherein at least one X² is NH,
and agriculturally acceptable salts thereof.

12. The compound of claim 1, wherein X¹-(G-X²)ₙ is selected from the group consisting of 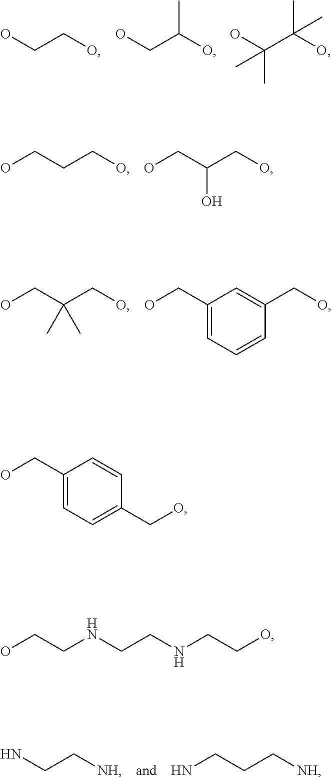
and agriculturally acceptable salts thereof.

13. The compound of claim 1, wherein X¹-(G-X²)ₙ is selected from the group consisting of 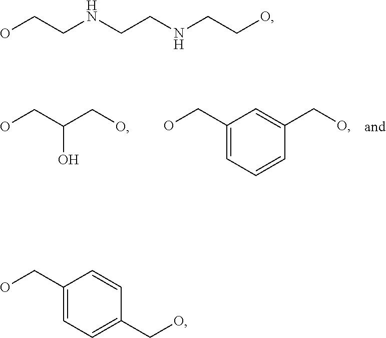
and agriculturally acceptable salts thereof.

14. The compound of claim 1, wherein X¹-(G-X²)ₙ is 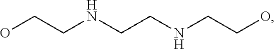
and agriculturally acceptable salts thereof.

15. The compound of claim 1, wherein n=0,
and agriculturally acceptable salts thereof.

16. The compound of claim 1, wherein n=1 to 4,
and agriculturally acceptable salts thereof.

17. The compound of claim 1, wherein each R^{A} and R^{B} are independently of formula (I) 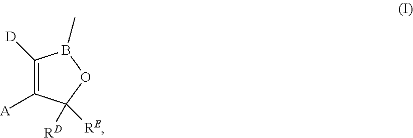
wherein A and D together with the carbon atoms to which they are attached form a 5, 6, or 7-membered fused ring which may be substituted by C₁₋₆-alkyl, C₁₋₆-alkoxy, hydroxy, halogen, nitro, nitrile, amino, amino substituted by one or more C₁₋₆-alkyl groups, carboxy, acyl, aryloxy, carbonamido, carbonamido substituted by C₁₋₆-alkyl, sulphonamido or trifluoromethyl, and
wherein R^{D} and R^{E} are independently hydrogen, substituted or unsubstituted C₁₋₆ alkyl, nitrile, nitro, aryl or arylalkyl; or R^{D} and R^{E} together form an alicyclic ring which is substituted or unsubstituted,
and agriculturally acceptable salts thereof.

18. The compound of claim 1, wherein each R^{A} and R^{B} are independently of formula (J) 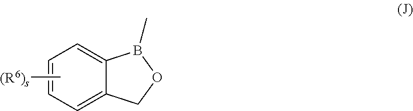
wherein s=0 to 4 and each R⁶ is independently alkyl, alkene, alkyne, haloalkyl, haloalkene, haloalkyne, alkoxy, alkeneoxy, haloalkoxy, aryl, heteroaryl, arylalkyl, arylalkene, arylalkyne, heteroarylalkyl, heteroarylalkene, heteroarylalkyne, halogen, hydroxyl, nitrile, amine, ester, carboxylic acid, ketone, alcohol, sufide, sulfoxide, sulfone, sulfoximine, sulfilimine, sulfonamide, sulfate, sulfonate, nitroalkyl, amide, oxime, imine, hydroxylamine, hydrazine, hydrazone, carbamate, thiocarbamate, urea, thiourea, carbonate, aryloxy, or heteroaryloxy; and
agriculturally acceptable salts thereof.

19. The compound of claim 18, wherein R⁶ is halogen.

20. The compound of claim 19, wherein s is 1.
